(19) United States
(12) Patent Application Publication
(10) Pub. No.: US 2026/0185894 A1
(43) Pub. Date: Jul. 2, 2026

(54) SYSTEM AND METHOD FOR DETECTING MULTIPLE LEAKS IN PIPELINES USING HYDRAULIC TRANSIENTS AND MACHINE LEARNING

(71) Applicant: KING FAHD UNIVERSITY OF PETROLEUM AND MINERALS, Dhahran (SA)

(72) Inventors: Muhammad WAQAR, Dhahran (SA); Azhar Mehmood MEMON, Dhahran (SA); Luai M. ALHEMS, Dhahran (SA)

(73) Assignee: KING FAHD UNIVERSITY OF PETROLEUM AND MINERALS, Dhahran (SA)

(21) Appl. No.: 19/006,845

(22) Filed: Dec. 31, 2024

(51) Int. Cl. G01M 3/28; E03B 7/00; F17D 5/02

(52) U.S. Cl. CPC G01M 3/2815; E03B 7/003; F17D 5/02

(57) ABSTRACT

A leak detection system and a method for detecting multiple simultaneous leaks in a pipeline system. The leak detection system includes a valve for perturbing fluid pressure, a detachable pressure measurement device, and a signal acquisition unit for acquiring transient pressure signals with random noise. A neural network model maps these signals to an output leak function, which is a probability density function proportional to pipeline length. The dimension of this function is fixed and independent of the number of leaks present. The system includes a display showing the output leak function alongside a pipeline diagram, indicating leak locations. The leak detection system facilitates efficient detection and localization of multiple leaks simultaneously, adapting to various pipeline configurations and operational conditions.

### STATEMENT REGARDING PRIOR DISCLOSURE BY THE INVENTORS

Aspects of this technology are described in an article Muhammad Waqar, Azhar M. Memon, Moez Louati, Mohamed S. Ghidaoui, Luai M. Alhems, Silvia Meniconi, Bruno Brunone, Caterina Capponi, Pipeline leak detection using hydraulic transients and domain-guided machine learning, Mechanical Systems and Signal Processing, Volume 224, 2025. The article was published online Sep. 25, 2024, and is herein incorporated by reference in its entirety.

### BACKGROUND

### Technical Field

The present disclosure is directed to the field of fluid transport systems and methods, specifically to leak detection in pipeline networks. More particularly, the present disclosure pertains to systems and methods for detecting multiple simultaneous leaks in pressurized pipeline systems using hydraulic transients and machine learning techniques.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Pressurized pipelines are vital for water distribution to cities and industries, yet they are vulnerable to leaks and other faults such as partial blockages and wall deterioration. For purposes of this disclosure, the invention focuses on the leakages. Other types of faults, if present in the system, are treated as noise when detecting leakages. A leaking pipeline does not merely represent a physical fault in the system; it signifies a contributor to non-revenue water (NRW) losses, waste of energy, and a burden on financial resources. Globally, NRW accounts for approximately 346 million cubic meters per day [See: Liemberger R, Wyatt A (2019) Quantifying the global non-revenue water problem. Water Supply 19 (3): 831-837]. A significant portion of this volume is attributed to leaks, reinforcing the urgency for effective solutions. Thus, the development of robust leak detection methods has emerged as an active and pressing area of research. The impetus for such advancements is twofold: on one hand, it addresses the immediate challenges faced by water agencies tasked with the management and maintenance of these pipelines; on the other hand, it presents an opportunity for broader economic benefits.

Current commercial methodologies for pipeline leak detection, including noise loggers [See: El-Abbasy M S, Mosleh F, Senouci A, Zayed T, Al-Derham H (2016) Locating leaks in water mains using noise loggers. Journal of Infrastructure Systems 22 (3): 04016012], listening rods [See: Hunaidi O, Chu W, Wang A, Guan W (2000) Detecting leaks in plastic pipes. Journal—American Water Works Association 92 (2): 82-94], ground penetrating radar [See: Eyuboglu S, Mahdi H, Al-Shukri H, Rock L (2003) Detection of water leaks using ground penetrating radar. Proceedings of the third international conference on applied geophysics, Orlando-FL, 8-12], the SAHARA system [See: Laven K, Amyot C, Knight M, Liew P, Jones C (2007) Leak detection on wastewater force mains and siphons in north America using the Sahara® acoustic system. Pipelines 2007: Advances and Experiences with Trenchless Pipeline Projects, 1-10], and smart-ball [See: Fletcher R, Chandrasekaran M (2008) Smartball™: a new approach in pipeline leak detection. 2008 7th International Pipeline Conference, American Society of Mechanical Engineers, 117-133], often face challenges with large-scale pipelines. These methods tend to be disruptive and intrusive, necessitating significant operational and financial expenditure for water supply agencies.

From a management viewpoint, these methods are usually carried out by the supplier's technicians, which can lead to waiting times and delays. Moreover, the majority of these techniques are passive; they depend on the manifestations of existing leaks, such as noise or flow disturbances, to signal their presence [See: Colombo A F, Lee P, Karney B W (2009) A selective literature review of transient-based leak detection methods. Journal of hydro-environment research 2 (4): 212-227]. This approach inherently limits their effectiveness, as they react to symptoms of leaks rather than actively detecting them. Consequently, despite the availability of these technologies, the persistent issue of NRW losses indicates a gap in the ability of current methods to detect and mitigate leaks efficiently.

Transient-based leak detection methods [See: Che T C, Duan H F, Lee P J (2021) Transient wave-based methods for anomaly detection in fluid pipes: A review. Mechanical Systems and Signal Processing 160:107874] are receiving immense attention as a viable strategy for identifying leaks and other faults. Leveraging mechanically induced hydraulic transient waves, which travel at the speed of sound, approximately 1000 m/s in metallic pipes and 400 m/s in non-metallic pipes [See: Chaudhry M H (2014) Applied Hydraulic Transients. Springer New York], this approach provides a non-disruptive and non-intrusive alternative suitable for large-scale pipelines.

As these waves travel along the pipeline, they reflect off physical discontinuities, including leaks, sending back signals that carry distinctive information about these features. Precisely, leaks or junctions for side-branches generate a negative pressure wave, while a partially closed valve introduces a positive pressure wave. The characteristic pattern of an extended partial blockage is a positive wave followed by a negative one, forming a ‘positive bell’ profile. Conversely, partial wall deterioration is indicated by a negative wave succeeded by a positive one, creating a ‘negative bell’ pattern. The time-of-arrival and magnitude of these reflected pressure waves are associated respectively with the location and size of discontinuity. Therefore, by analyzing the measured transient responses, it becomes possible to decode these signals, pinpointing the presence, location, and size of leaks and other faults with precision. In addition, the short duration and simplicity of the transient tests give the water system technicians complete autonomy and guarantee minimum costs. However, the task is not straightforward as the measured signals are inevitably contaminated by environmental noise [See: Keramat A, Wang X, Louati M, Meniconi S, Brunone B, Ghidaoui M S (2019) Objective functions for transient-based pipeline leakage detection in a noisy environment: least square and matched-filter. Journal of Water Resources Planning and Management 145 (10): 04019042; Wang X, Lin J, Ghidaoui M S (2019) Usage and effect of multiple transient tests for pipeline leak detection: Noise cancellation, modeling uncertainty identification, and spectral-based methods. Journal of Hydraulic Engineering (under review); Wang X, Lin J, Keramat A, Ghidaoui M S, Meniconi S, Brunone B (2019) Matched-field processing for leak localization in a viscoelastic pipe: An experimental study. Mechanical Systems and Signal Processing 124:459-478; and Waqar M, Louati M, Ghidaoui M S (2023) Time-reversal technique for pipeline defect detection. Water research 243:120375].

To deal with noise, the literature has traditionally focused on physics-driven and inversion-based techniques [See: Brunone B, Maietta F, Capponi C, Keramat A, Meniconi S (2022) A review of physical experiments for leak detection in water pipes through transient tests for addressing future research. Journal of Hydraulic Research 60 (6): 894-906], including inverse transient analysis [See: Liggett J A, Chen L C (1994) Inverse transient analysis in pipe networks. Journal of hydraulic engineering 120 (8): 934-955; and Covas D, Ramos H (2010) Case studies of leak detection and location in water pipe systems by inverse transient analysis. Journal of Water Resources Planning and Management 136 (2): 248-257], time-domain reflectometry [See: Brunone B (1999) Transient test-based technique for leak detection in outfall pipes. Journal of water resources planning and management 125 (5): 302-306], frequency-response based techniques [See: Lee P J, Vitkovsky J P, Lambert M F, Simpson A R, Liggett J A (2005) Frequency domain analysis for detecting pipeline leaks. Journal of Hydraulic Engineering 131 (7): 596-604; Lee P J, Vitkovsky J P, Lambert M F, Simpson A R, Liggett J A (2005) Leak location using the pattern of the frequency response diagram in pipelines: a numerical study. Journal of Sound and Vibration 284 (3-5): 1051-1073; Lee P J, Lambert M F, Simpson A R, Vitkovsky J P, Liggett J (2006) Experimental verification of the frequency response method for pipeline leak detection. Journal of Hydraulic research 44 (5): 693-707; Gong J, Zecchin A C, Simpson A R, Lambert M F (2014) Frequency response diagram for pipeline leak detection: Comparing the odd and even harmonics. Journal of Water Resources Planning and Management 140 (1): 65-74; Gong J, Simpson A R, Lambert M F, Zecchin A C, Kim Y I, Tijsseling A S (2012) Detection of distributed deterioration in single pipes using transient reflections. Journal of Pipeline Systems Engineering and Practice 4 (1): 32-40; Mpesha W, Gassman S L, Chaudhry M H (2001) Leak detection in pipes by frequency response method. Journal of Hydraulic Engineering 127 (2): 134-147], and time-reversal methods [See: Wang X, Ghidaoui M S (2018) Pipeline leak detection using the matched-field processing method. Journal of Hydraulic Engineering 144 (6): 04018030; Waqar M, Louati M, Ghidaoui M S (2023) Time-reversal technique for pipeline defect detection. Water research 243:120375]. Most of these methods have undergone rigorous testing predominantly in controlled laboratory environments with few attempts in the real pipe systems [See: Stephens M L (2008) Transient response analysis for fault detection and pipeline wall condition assessment in field water transmission and distribution pipelines and networks. Ph.D. thesis, The University of Adelaide, South Australia; Covas D, Stoianov I, Ramos H, Graham N, Maksimovic C (2004) The dynamic effect of pipe-wall viscoelasticity in hydraulic transients. part i—experimental analysis and creep characterization. Journal of Hydraulic Research 42 (5): 517-532; Waqar M (2022) Condition assessment of pressurized pipelines using transient waves and time-reversal technique. Ph.D. thesis, Hong Kong University of Science and Technology, Hong Kong; Meniconi S, Capponi C, Frisinghelli M, Brunone B (2021) Leak detection in a real transmission main through transient tests: Deeds and misdeeds. Water Resources Research 57 (3): e2020WR027838; and Meniconi S, Brunone B, Frisinghelli M (2018) On the role of minor branches, energy dissipation, and small defects in the transient response of transmission mains. Water 10 (2): 187].

While the research community continues to extend and enhance these modeling and inversion-based approaches, there is a growing interest in utilizing data-driven machine learning. For instance, in 2019, Zhou et al. [See: Zhou B, Lau V, Wang X (2019) Machine-learning-based leakage-event identification for smart water supply systems. IEEE Internet of Things Journal 7 (3): 2277-2292] utilized resonant frequency responses to train a Convolutional Neural Network (CNN) using a novel fusion-enhanced stochastic optimization algorithm combined with a pooling network strategy. Their study successfully detected single leaks in a simple single pipeline system, even in the presence of noise with a signal-to-noise ratio (SNR) as low as 0 dB. The approach was validated through numerical experiments. In the following year, Bohorquez et al. [See: Bohorquez J, Alexander B, Simpson A R, Lambert M F (2020) Leak detection and topology identification in pipelines using fluid transients and artificial neural networks. Journal of Water Resources Planning and Management 146 (6): 04020040] used time-domain pressure head signals to train both an Artificial Neural Network (ANN) and a 1-D Convolutional Neural Network (1D-CNN) in a noise-free environment, aiming for a single leak detection and recognizing sudden area changes in a single pipeline. This method was only validated numerically.

In 2021 another paper [See: Bohorquez J, Simpson A R, Lambert M F, Alexander B (2021) Merging fluid transient waves and artificial neural networks for burst detection and identification in pipelines. Journal of Water Resources Planning and Management 147 (1): 04020097] described training ANNs using burst-induced transient signals for the detection and localization of single burst occurrences in a single pipeline system. Their method was validated using both numerical simulations and laboratory experiments. In the same year, Liao et al. [See: Liao Z, Yan H, Tang Z, Chu X, Tao T (2021) Deep learning identifies leak in water pipeline system using transient frequency response. Process Safety and Environmental Protection 155:355-365] adopted resonant frequency responses to train a multi-layer dense-net (ANN) algorithm, which could detect a single leak in large-scale pipeline networks, with validation conducted through numerical dataset.

In 2022, Ayati et al. [See: Ayati A H, Haghighi A, Ghafouri H R (2022) Machine learning assisted model for leak detection in water distribution networks using hydraulic transient flows. Journal of Water Resources Planning and Management 148 (2): 04021104] classified leaks in pipeline networks by employing resonant frequency responses and Neighborhood Component Analysis (NCA). They also focused on single leak detection and validated their approach both numerically and in laboratory experiments. More recently, Waqar et al. [See: Waqar M, Louati M, Li S, Ghidaoui M S (2022) Physics-informed neural network model for transient wave propagation in a pressurized pipeline. Proceedings of the 39th IAHR World Congress, Vol. 19, 24] harnessed the capabilities of Physics-Informed Neural Networks (PINNs), integrating them for the first time with the principles of hydraulic transients in pipeline systems. The model used a 1-D wave equation to predict the transient wave propagation in a single pipeline. The study conducted a detailed sensitivity analysis regarding the architecture of the neural network and the nature of the input training data, underpinned by numerical validation. In parallel, Ye et al. [See: Ye J, Do N C, Zeng W, Lambert M (2022) Physics-informed neural networks for hydraulic transient analysis in pipeline systems. Water Research 221:118828] also employed a PINN, informed by the water-hammer equations with frictional and visco-elastic damping considerations. In addition to numerical exploration, the authors validated their findings through laboratory experiments, providing the efficacy of their findings.

These studies collectively underscore the progressive role of machine learning (ML) in enhancing the precision and reliability of leak detection in pipeline systems, showcasing a blend of diverse ML algorithms with remarkable performances. However, it is found that the majority of research efforts have concentrated on detecting a single leak in a given pipeline. Contrarily, the possibility of multiple simultaneous leaks within a pipeline system cannot be overlooked, especially considering that the occurrence of one leak may compromise the structural integrity of the system, thereby increasing the likelihood of subsequent breaches [See: White G (2017) Layered asset management supports aging pipes. Opflow 43 (10): 18-20]. This limitation necessitates the development of a novel framework specifically designed to detect multiple leaks simultaneously. Additionally, the incorporation of modeling uncertainties through a model refinement approach represents a significant contribution to the field, as this methodology has not been previously explored within this context.

In practical applications, water pipeline systems are often subjected to significant levels of noise, originating from a variety of sources, including flow turbulence, mechanical vibrations induced by pumps and flow regulation devices, and fluctuations in consumer usage and demand [See: Wang X, Ghidaoui M S (2018) Pipeline leak detection using the matched-field processing method. Journal of Hydraulic Engineering 144 (6): 04018030; Dubey A, Li Z, Lee P, Murch R (2019) Measurement and characterization of acoustic noise in water pipeline channels. IEEE Access 7:56890-56903]. Additionally, the environmental context of the pipelines, whether they are above ground or buried, and their proximity to highways, railway tracks, or other infrastructure, further contributes to noise characteristics. As such, the measured transient signals are inevitably tainted with noise. The relation hₘ(t, s^{L}, x^{L}, n^{L}) represents the measured transient response of the system, which can be approximated as:

$$\\ \begin{matrix}{h}_{m} ( t , {s}^{L} , {x}^{L} , {n}^{L} ) = {h}_{c} ( t , {s}^{L} , {x}^{L} , {n}^{L} ) + n ( t ) & ( 1 )\end{matrix}$$

where s^{L} denotes the leak size, x^{L} is the leak location, n^{L} is the number of leaks, t denotes the time vector, n is the noise, and h_{c} is the predicted transient response and is denoted as:

$$\\ \begin{matrix}{h}_{c} ( t , {x}^{L} , {s}^{L} , {n}^{L} ) = ForwardModel {h}_{c} ( {x}^{L} , {s}^{L} , {n}^{L} ) & ( 2 )\end{matrix}$$

Within this framework, the ForwardModel can be an explicit/implicit time-domain model, leveraging techniques like the Method of Characteristics or finite volume methods [See: Chaudhry M H (2014) Applied Hydraulic Transients. Springer New York]. Alternatively, the ForwardModel could be a frequency domain-based model, utilizing either frequency response functions or impedance-based models. A challenge lies in extracting the leak information, namely s^{L}, x^{L} and n^{L}, from the noisy signal hₘ(t). This task is significantly influenced by the signal-to-noise ratio (SNR). For the leakage detection problem, the SNR is defined as [See: Waqar M, Louati M, Ghidaoui M S (2023) Time-reversal technique for pipeline defect detection. Water research 243:120375; and Wang X, Ghidaoui M S (2018) Pipeline leak detection using the matched-field processing method. Journal of Hydraulic Engineering 144 (6): 04018030]:

$$\\ \begin{matrix}S N R = 20 {log}_{10} ( Δ {h}^{L} / {σ}_{noise} ) & ( 3 )\end{matrix}$$

where Δh^{L} is average pressure head difference caused by the leak, and σₙₒᵢₛₑ is the standard deviation of noise.

Conventionally, retrieving defect information from noisy measurements is approached as an inverse problem. This process involves estimating the defect characteristics from observed data, typically governed by the equation:

$$\\ \begin{matrix}\{ \hat{x} {}^{L} , \hat{s} {}^{L} , \hat{n} {}^{L} \} = InverseModel ( {h}_{m} ( t ) ) & ( 4 )\end{matrix}$$

In this equation, {\hat{x}^{L}, ŝ^{L}, \hat{n}^{L}} represent the estimated leak characteristics. The InverseModel function encapsulates the optimization approach to infer defect information from the observed data. However, this approach is inherently ill-posed due to the intrinsic noise in the measured signals. As such, the accuracy and reliability of the solutions derived from this model are heavily dependent on the algorithm employed [See: Vítkovsky J P, Simpson A R, Lambert M F (2000) Leak detection and calibration using transients and genetic algorithms. Journal of water resources planning and management 126 (4): 262-265; Stephens M, Lambert A, Simpson J, Vitkovsky J, Nixon J (2004) Field tests for leakage, air pocket, and discrete blockage detection using inverse transient analysis in water distribution pipes. Critical Transitions in Water and Environmental Resources Management, 1-10; and Stephens M, Simpson A, Lambert M (2008) Internal wall condition assessment for water pipelines using inverse transient analysis. Water Distribution Systems Analysis 2008, 1-11]. In many cases, the presence of noise can lead to ambiguous or multiple solutions, resulting in false alarms [See: Keramat A, Wang X, Louati M, Meniconi S, Brunone B, Ghidaoui M S (2019) Objective functions for transient-based pipeline leakage detection in a noisy environment: least square and matched-filter. Journal of Water Resources Planning and Management 145 (10): 04019042; and Wang X, Lin J, Keramat A, Ghidaoui M S, Meniconi S, Brunone B (2019) Matched-field processing for leak localization in a viscoelastic pipe: An experimental study. Mechanical Systems and Signal Processing 124:459-478].

In the literature, the use of a machine learning algorithm (e.g., ANN, CNN or NCA, as described previously) as a surrogate inverse model is proposed to map noisy measurements to specific defect information. The underlying concept is mathematically represented as follows:

$$\\ \begin{matrix}\{ \hat{x} {}^{L} , \hat{s} {}^{L} \} = ML ( {h}_{m} ( t , {s}^{L} , {x}^{L} , {n}^{L} ) ) & ( 5 )\end{matrix}$$

where ML denotes an arbitrary machine learning model, and {\hat{x}^{L}, ŝ^{L}} symbolize the defect characteristics inferred from the hydraulic measurements hₘ(t, x^{L}, s^{L}). An approach to solve this equation (5) presents distinct challenges, as discussed in the proceeding paragraphs.

In the framework, where leak parameters are directly estimated as outputs, a machine learning model trained for a single leak is predisposed to detect only one leak, whereas a model trained for two leaks will necessarily identify exactly two, regardless of the actual conditions. This reveals a limitation of adaptability of the existing framework to varying numbers of actual leaks. Such a limitation originates from the architecture of the machine learning model, designed to detect only a specific number of leaks, n_{L}. As a result, the model inherently biases its predictions towards the number of leaks for which it was initially trained. In practical scenarios, where the actual number of leaks is unknown, this bias leads to inaccurate predictions. Further, adjusting the model to predict an alternate number of leaks would require changing the dimension of the output vector within the machine learning architecture. However, the architecture imposes strict limitations on the dimensions of the output vector, making such adjustments impractical. This inflexibility hinders the ability to fine-tune models for accurately detecting multiple leaks after their initial training. Furthermore, this framework of prediction, driven by training constraints of the model, raises significant concerns about the accuracy and practicality of the detection method. It also highlights the need for developing more adaptable and accurate leak detection framework strategies that can effectively manage the dynamic nature of pipeline systems.

Accordingly, it is one object of the present disclosure to provide a system and a method for non-disruptive, non-intrusive, and active leak detection, which can efficiently identify multiple simultaneous leaks in large-scale pipeline networks. The present disclosure seeks to address the challenges associated with detecting multiple leaks simultaneously in complex pipeline configurations, including tree-type networks with three or more connected pipes, while accommodating variability in operational conditions, such as valve closure time and pre-transient flow rate. The present disclosure aims to provide a flexible and accurate approach to detecting and localizing multiple leaks in pressurized pipeline systems, potentially reducing non-revenue water losses and improving the efficiency of water distribution networks.

### SUMMARY

In an exemplary embodiment, a leak detection system for detecting a plurality of simultaneous leaks within a pipeline system that transports a fluid is described, comprising: a valve located at an output port of the pipeline system for perturbing a pressure head in the fluid in response to a valve closure by the valve; a detachable pressure measurement device for measuring a pressure head at the output port; a signal acquisition unit for acquiring a transient pressure head signal from the pressure measurement device, wherein the transient pressure head signal includes a random noise; a neural network model that maps the transient pressure head signal to an output leak function, wherein the output leak function is a probability density function that is proportional to a length of the pipeline system, wherein a dimension of the output leak function is a fixed dimension of an output layer of the neural network model that is independent of a number of leaks; and a display for displaying the output leak function from the neural network model in conjunction with a drawing of the pipeline system with indications for locations of the plurality of leaks.

In some embodiments, the display is configured to display the output leak function in which each potential leak point is represented by a density-like lobe, centered at a respective leak location.

In some embodiments, the display is configured to display the output leak function in which a peak amplitude of the lobe indicates a leak size.

In some embodiments, the neural network model outputs the output leak function in which a standard deviation of the lobe is proportional to wavelength of the acquired transient pressure head signal.

In some embodiments, the pipeline system is a tree-type network having three or more connected pipes.

In some embodiments, the display is configured to display the output leak function as a plot in which a horizontal axis is normalized against pipe length, and a vertical axis is normalized in relation to a cross-sectional area of the pipeline system.

In some embodiments, the valve is a shut-off valve, and wherein the neural network model is calibrated to accommodate for variability of closure time of the shut-off value.

In some embodiments, the valve is a shut-off valve, and wherein the neural network model is calibrated to accommodate for variations in pre-transient flow rate at the valve location.

In some embodiments, the valve is a shut-off valve, and wherein the neural network model is calibrated to accommodate for a combined variability of valve closure time and a pre-transient flowrate.

In some embodiments, the valve is a shut-off valve, and wherein the neural network model is calibrated to accommodate for pre-transient pressure head in the pipeline system.

In some embodiments, the detachable pressure measurement device includes a pressure monitoring device, the system further comprising a connection adapter in which one end is detachably connected to the output port of the pipeline system and another end includes a device port for connecting the pressure monitoring device.

In some embodiments, the connection adapter is one of a plurality of interchangeable connection adapters of different inner diameters for connection to different types of output ports of various diameters.

In another exemplary embodiment, a method for detecting a plurality of simultaneous leaks within a pipeline system that transports a fluid is described, comprising: perturbing a pressure head in the fluid, by a valve located at an output port of the pipeline system, in response to a valve closure by the valve; measuring, using a detachable pressure measurement device, a pressure head at the output port; acquiring, by a signal acquisition unit, a transient pressure head signal at the output port, wherein the transient pressure head signal includes a random noise; generating an output leak function by a neural network model, based on the transient pressure head signal, wherein the output leak function is a probability density function that is proportional to a length of the pipeline system, wherein a dimension of the output leak function is a fixed dimension of an output layer of the neural network model that is independent of a number of leaks; and displaying, by a display, the output leak function from the neural network model in conjunction with a drawing of the pipeline system with indications for locations of the plurality of leaks.

In some embodiments, the displaying includes displaying the output leak function in which each potential leak point is represented by a density-like lobe, centered at a respective leak location.

In some embodiments, the displaying includes displaying the output leak function in which a peak amplitude of the lobe indicates a leak size.

In some embodiments, the generating, by the neural network model, includes generating the output leak function in which a standard deviation of the lobe is proportional to wavelength of the acquired transient pressure head signal.

In some embodiments, the displaying displays the output leak function as a plot in which a horizontal axis is normalized against pipe length, and a vertical axis is normalized in relation to a cross-sectional area of the pipeline system.

In some embodiments, the output port is configured with a shut-off valve, the method further comprising calibrating the neural network model to accommodate for variability of valve closure time.

In some embodiments, the output port is configured with a shut-off valve, the method further comprising calibrating the neural network model to accommodate for variations in a pre-transient flow rate at the valve location.

In some embodiments, the output port is configured with a shut-off valve, the method further comprising calibrating the neural network model to accommodate for a combined variability of valve closure time and a pre-transient flowrate.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a schematic diagram illustrating a leak detection system for detecting multiple simultaneous leaks within a pipeline system that transports a fluid, according to certain embodiments.

FIG. 2 is an exemplary representation of multiple pipeline leaks as a probability density function, according to certain embodiments.

FIG. 3 is an exemplary flowchart illustrating a methodology for developing and validating a machine learning model for leak detection, according to certain embodiments.

FIG. 4 is an exemplary flowchart of a method for detecting multiple simultaneous leaks within a pipeline system that transports a fluid, according to certain embodiments.

FIG. 5A is an exemplary graph depicting numerically simulated signal without noise for one leak scenario, according to certain embodiments.

FIG. 5B is an exemplary graph depicting numerically simulated signal without noise for two leak scenario, according to certain embodiments.

FIG. 5C is an exemplary graph depicting numerically simulated signal without noise for three leak scenario, according to certain embodiments.

FIG. 5D is an exemplary graph depicting numerically simulated signal with noise for one leak scenario, according to certain embodiments.

FIG. 5E is an exemplary graph depicting numerically simulated signal with noise for two leak scenario, according to certain embodiments.

FIG. 5F is an exemplary graph depicting numerically simulated signal with noise for three leak scenario, according to certain embodiments.

FIG. 6A is an exemplary graph depicting pressure-time signals in step response format for one leak scenario, according to certain embodiments.

FIG. 6B is an exemplary graph depicting pressure-time signals in pulse response format for one leak scenario, according to certain embodiments.

FIG. 6C is an exemplary graph depicting pressure-time signals in step response format for two leak scenario, according to certain embodiments.

FIG. 6D is an exemplary graph depicting pressure-time signals in pulse response format for two leak scenario, according to certain embodiments.

FIG. 6E is an exemplary graph depicting pressure-time signals in step response format for three leak scenario, according to certain embodiments.

FIG. 6F is an exemplary graph depicting pressure-time signals in pulse response format for three leak scenario, according to certain embodiments.

FIG. 7A is an exemplary graph depicting numerically simulated leak properties in the hydraulic model for one leak scenario, according to certain embodiments.

FIG. 7B is an exemplary graph depicting corresponding leak function for one leak scenario, according to certain embodiments.

FIG. 7C is an exemplary graph depicting numerically simulated leak properties in the hydraulic model for two leak scenario, according to certain embodiments.

FIG. 7D is an exemplary graph depicting corresponding leak function for two leak scenario, according to certain embodiments.

FIG. 7E is an exemplary graph depicting numerically simulated leak properties in the hydraulic model for three leak scenario, according to certain embodiments.

FIG. 7F is an exemplary graph depicting corresponding leak function for three leak scenario, according to certain embodiments.

FIG. 8A is an exemplary graph illustrating Mean Squared Error (MSE) loss function over epochs for training, validation, and test sets of an Artificial Neural Network (ANN) model, according to certain embodiments.

FIG. 8B is an exemplary graph illustrating gradient of the loss function over epochs for the ANN model, according to certain embodiments.

FIG. 8C is an exemplary graph illustrating validation fails over epochs for the ANN model, according to certain embodiments.

FIG. 9A is an exemplary scatter plot of performance of the ANN model for predicting leak properties across training dataset, according to certain embodiments.

FIG. 9B is an exemplary scatter plot of performance of the ANN model for predicting leak properties across validation dataset, according to certain embodiments.

FIG. 9C is an exemplary scatter plot of performance of the ANN model for predicting leak properties across testing dataset, according to certain embodiments.

FIG. 10A is an exemplary comparative plot of true versus predicted leak properties for the ANN model across training dataset for one leak scenario, according to certain embodiments.

FIG. 10B is an exemplary comparative plot of true versus predicted leak properties for the ANN model across training dataset for two leak scenario, according to certain embodiments.

FIG. 10C is an exemplary comparative plot of true versus predicted leak properties for the ANN model across training dataset for three leak scenario, according to certain embodiments.

FIG. 10D is an exemplary comparative plot of true versus predicted leak properties for the ANN model across validation dataset for one leak scenario, according to certain embodiments.

FIG. 10E is an exemplary comparative plot of true versus predicted leak properties for the ANN model across validation dataset for two leak scenario, according to certain embodiments.

FIG. 10F is an exemplary comparative plot of true versus predicted leak properties for the ANN model across validation dataset for three leak scenario, according to certain embodiments.

FIG. 10G is an exemplary comparative plot of true versus predicted leak properties for the ANN model across testing dataset for one leak scenario, according to certain embodiments.

FIG. 10H is an exemplary comparative plot of true versus predicted leak properties for the ANN model across testing dataset for two leak scenario, according to certain embodiments.

FIG. 10I is an exemplary comparative plot of true versus predicted leak properties for the ANN model across testing dataset for three leak scenario, according to certain embodiments.

FIG. 11A is an exemplary comparative plot of true versus predicted leak properties for an adapted ANN model (AdaptedModel-1) across training dataset for one leak scenario, according to certain embodiments.

FIG. 11B is an exemplary comparative plot of true versus predicted leak properties for the AdaptedModel-1 across training dataset for two leak scenario, according to certain embodiments.

FIG. 11C is an exemplary comparative plot of true versus predicted leak properties for the AdaptedModel-1 across training dataset for three leak scenario, according to certain embodiments.

FIG. 11D is an exemplary comparative plot of true versus predicted leak properties for the AdaptedModel-1 across validation dataset for one leak scenario, according to certain embodiments.

FIG. 11E is an exemplary comparative plot of true versus predicted leak properties for the AdaptedModel-1 across validation dataset for two leak scenario, according to certain embodiments.

FIG. 11F is an exemplary comparative plot of true versus predicted leak properties for the AdaptedModel-1 across validation dataset for three leak scenario, according to certain embodiments.

FIG. 11G is an exemplary comparative plot of true versus predicted leak properties for the AdaptedModel-1 across testing dataset for one leak scenario, according to certain embodiments.

FIG. 11H is an exemplary comparative plot of true versus predicted leak properties for the AdaptedModel-1 across testing dataset for two leak scenario, according to certain embodiments.

FIG. 11I is an exemplary comparative plot of true versus predicted leak properties for the AdaptedModel-1 across testing dataset for three leak scenario, according to certain embodiments.

FIG. 12A is an exemplary comparative plot of true versus predicted leak properties for another adapted ANN model (AdaptedModel-2) across training dataset for one leak scenario, according to certain embodiments.

FIG. 12B is an exemplary comparative plot of true versus predicted leak properties for the AdaptedModel-2 across training dataset for two leak scenario, according to certain embodiments.

FIG. 12C is an exemplary comparative plot of true versus predicted leak properties for the AdaptedModel-2 across training dataset for three leak scenario, according to certain embodiments.

FIG. 12D is an exemplary comparative plot of true versus predicted leak properties for the AdaptedModel-2 across validation dataset for one leak scenario, according to certain embodiments.

FIG. 12E is an exemplary comparative plot of true versus predicted leak properties for the AdaptedModel-2 across validation dataset for two leak scenario, according to certain embodiments.

FIG. 12F is an exemplary comparative plot of true versus predicted leak properties for the AdaptedModel-2 across validation dataset for three leak scenario, according to certain embodiments.

FIG. 12G is an exemplary comparative plot of true versus predicted leak properties for the AdaptedModel-2 across testing dataset for one leak scenario, according to certain embodiments.

FIG. 12H is an exemplary comparative plot of true versus predicted leak properties for the AdaptedModel-2 across testing dataset for two leak scenario, according to certain embodiments.

FIG. 12I is an exemplary comparative plot of true versus predicted leak properties for the AdaptedModel-2 across testing dataset for three leak scenario, according to certain embodiments.

FIG. 13A is an exemplary comparative plot of true versus predicted leak properties for yet another adapted ANN model (AdaptedModel-3) across training dataset for a first sample, according to certain embodiments.

FIG. 13B is an exemplary comparative plot of true versus predicted leak properties for the AdaptedModel-3 across training dataset for a second sample, according to certain embodiments.

FIG. 13C is an exemplary comparative plot of true versus predicted leak properties for the AdaptedModel-3 across training dataset for a third sample, according to certain embodiments.

FIG. 13D is an exemplary comparative plot of true versus predicted leak properties for the AdaptedModel-3 across validation dataset for the first sample, according to certain embodiments.

FIG. 13E is an exemplary comparative plot of true versus predicted leak properties for the AdaptedModel-3 across validation dataset for the second sample, according to certain embodiments.

FIG. 13F is an exemplary comparative plot of true versus predicted leak properties for the AdaptedModel-3 across validation dataset for the third sample, according to certain embodiments.

FIG. 13G is an exemplary comparative plot of true versus predicted leak properties for the AdaptedModel-3 across testing dataset for the first sample, according to certain embodiments.

FIG. 13H is an exemplary comparative plot of true versus predicted leak properties for the AdaptedModel-3 across testing dataset for the second sample, according to certain embodiments.

FIG. 13I is an exemplary comparative plot of true versus predicted leak properties for the AdaptedModel-3 across testing dataset for the third sample, according to certain embodiments.

FIG. 14A is an exemplary graph illustrating comparative evaluation of Mean Squared Error (MSE) across different models, from the BaseModel to the AdaptedModel-3, for each of the training, validation and testing phases, according to certain embodiments.

FIG. 14B is an exemplary graph illustrating comparative evaluation of Root Mean Squared Error (RMSE) across different models, from the BaseModel to the AdaptedModel-3, for each of the training, validation and testing phases, according to certain embodiments.

FIG. 14C is an exemplary graph illustrating comparative evaluation of Mean Absolute Error (MAE) across different models, from the BaseModel to the AdaptedModel-3, for each of the training, validation and testing phases, according to certain embodiments.

FIG. 14D is an exemplary graph illustrating comparative evaluation of R-squared values across different models, from the BaseModel to the AdaptedModel-3, for each of the training, validation and testing phases, according to certain embodiments.

FIG. 14E is an exemplary graph illustrating comparative evaluation of Pearson Correlation Coefficient (PCC) across different models, from the BaseModel to the AdaptedModel-3, for each of the training, validation and testing phases, according to certain embodiments.

FIG. 15A is an exemplary schematic diagram of a pipe-in-series system with two pipes, according to certain embodiments.

FIG. 15B is an exemplary schematic diagram of a tree-type network with three pipelines, according to certain embodiments.

FIG. 16A is an exemplary comparative plot of true versus predicted leak properties for a pipe-in-series system across training dataset for a first example scenario, according to certain embodiments.

FIG. 16B is an exemplary comparative plot of true versus predicted leak properties for the pipe-in-series system across training dataset for a second example scenario, according to certain embodiments.

FIG. 16C is an exemplary comparative plot of true versus predicted leak properties for the pipe-in-series system across training dataset for a third example scenario, according to certain embodiments.

FIG. 16D is an exemplary comparative plot of true versus predicted leak properties for the pipe-in-series system across validation dataset for the first example scenario, according to certain embodiments.

FIG. 16E is an exemplary comparative plot of true versus predicted leak properties for the pipe-in-series system across validation dataset for the second example scenario, according to certain embodiments.

FIG. 16F is an exemplary comparative plot of true versus predicted leak properties for the pipe-in-series system across validation dataset for the third example scenario, according to certain embodiments.

FIG. 16G is an exemplary comparative plot of true versus predicted leak properties for the pipe-in-series system across testing dataset for the first example scenario, according to certain embodiments.

FIG. 16H is an exemplary comparative plot of true versus predicted leak properties for the pipe-in-series system across testing dataset for the second example scenario, according to certain embodiments.

FIG. 16I is an exemplary comparative plot of true versus predicted leak properties for the pipe-in-series system across testing dataset for the third example scenario, according to certain embodiments.

FIG. 17A is an exemplary comparative plot of true versus predicted leak properties for a tree-type pipe system across training dataset for a first example scenario, according to certain embodiments.

FIG. 17B is an exemplary comparative plot of true versus predicted leak properties for the tree-type pipe system across training dataset for a second example scenario, according to certain embodiments.

FIG. 17C is an exemplary comparative plot of true versus predicted leak properties for the tree-type pipe system across training dataset for a third example scenario, according to certain embodiments.

FIG. 17D is an exemplary comparative plot of true versus predicted leak properties for the tree-type pipe system across validation dataset for the first example scenario, according to certain embodiments.

FIG. 17E is an exemplary comparative plot of true versus predicted leak properties for the tree-type pipe system across validation dataset for the second example scenario, according to certain embodiments.

FIG. 17F is an exemplary comparative plot of true versus predicted leak properties for the tree-type pipe system across validation dataset for the third example scenario, according to certain embodiments.

FIG. 17G is an exemplary comparative plot of true versus predicted leak properties for the tree-type pipe system across testing dataset for the first example scenario, according to certain embodiments.

FIG. 17H is an exemplary comparative plot of true versus predicted leak properties for the tree-type pipe system across testing dataset for the second example scenario, according to certain embodiments.

FIG. 17I is an exemplary comparative plot of true versus predicted leak properties for the tree-type pipe system across testing dataset for the third example scenario, according to certain embodiments.

FIG. 18A is an exemplary graph illustrating Mean Squared Error (MSE) loss function over epochs for training, validation, and test sets of the AdaptedModel-1, according to certain embodiments.

FIG. 18B is an exemplary graph illustrating gradient of the loss function over epochs for the AdaptedModel-1, according to certain embodiments.

FIG. 18C is an exemplary graph illustrating validation fails over epochs for the AdaptedModel-1, according to certain embodiments.

FIG. 19A is an exemplary graph illustrating Mean Squared Error (MSE) loss function over epochs for training, validation, and test sets of the AdaptedModel-2, according to certain embodiments.

FIG. 19B is an exemplary graph illustrating gradient of the loss function over epochs for the AdaptedModel-2, according to certain embodiments.

FIG. 19C is an exemplary graph illustrating validation fails over epochs for the AdaptedModel-2, according to certain embodiments.

FIG. 20A is an exemplary graph illustrating Mean Squared Error (MSE) loss function over epochs for training, validation, and test sets of the AdaptedModel-3, according to certain embodiments.

FIG. 20B is an exemplary graph illustrating gradient of the loss function over epochs for the AdaptedModel-3, according to certain embodiments.

FIG. 20C is an exemplary graph illustrating validation fails over epochs for the AdaptedModel-3, according to certain embodiments.

FIG. 21A is an exemplary graph illustrating performance metrics for a pipe-in-series system along with regression plot for training stage, according to certain embodiments.

FIG. 21B is an exemplary graph illustrating performance metrics for the pipe-in-series system along with regression plot for validation stage, according to certain embodiments.

FIG. 21C is an exemplary graph illustrating performance metrics for the pipe-in-series system along with regression plot for testing stage, according to certain embodiments.

FIG. 22A is an exemplary graph illustrating performance metrics for a tree-type pipe system along with regression plot for training stage, according to certain embodiments.

FIG. 22B is an exemplary graph illustrating performance metrics for the tree-type pipe system along with regression plot for validation stage, according to certain embodiments.

FIG. 22C is an exemplary graph illustrating performance metrics for the tree-type pipe system along with regression plot for testing stage, according to certain embodiments.

FIG. 23 is an illustration of a non-limiting example of details of computing hardware used in a computing unit of the leak detection system, according to certain embodiments.

FIG. 24 is an exemplary schematic diagram of a data processing system used within the computing unit, according to certain embodiments.

FIG. 25 is an exemplary schematic diagram of a processor used with the computing unit, according to certain embodiments.

FIG. 26 is an illustration of a non-limiting example of distributed components which may share processing with a controller, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to a leak detection system and a method for detecting multiple simultaneous leaks within a pipeline system that transports a fluid. The present disclosure provides a framework for detecting multiple leaks simultaneously using a single machine learning model, without constraining the target vector based on the number of leaks. The disclosed approach facilitates the detection of multiple leaks without the need to adjust the model architecture, providing a more flexible and adaptable framework for leak detection in complex pipeline systems, and potentially improving the accuracy and reliability of leak detection in noisy environments. Furthermore, the incorporation of modeling uncertainties through a model refinement approach represents a significant advancement in the field of leak detection in pressurized pipeline systems.

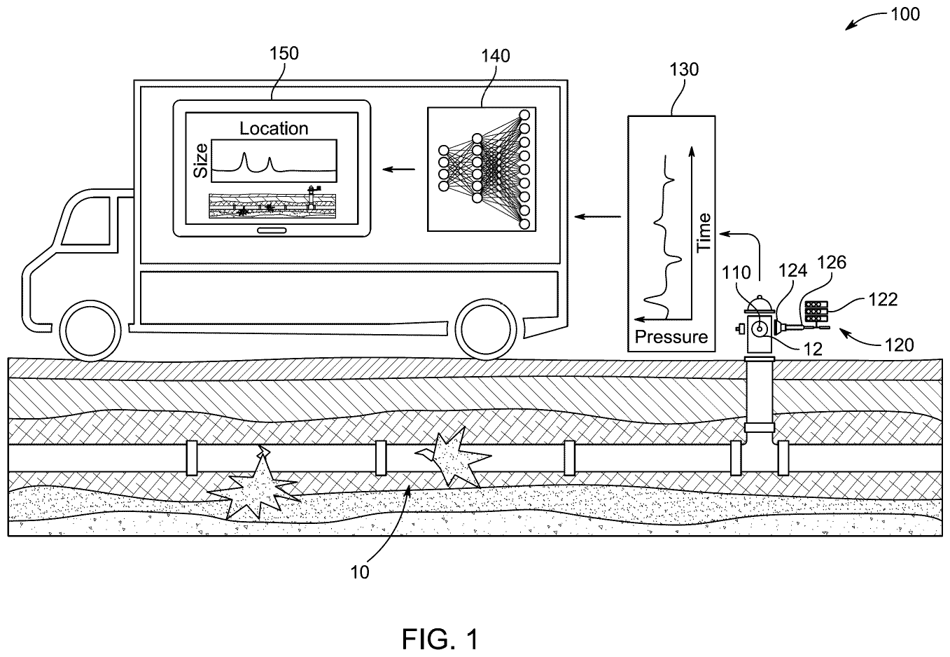

Referring to FIG. 1, illustrated is a schematic diagram of a leak detection system (as represented by reference numeral 100) for detecting multiple simultaneous leaks within a pipeline system 10 that transports a fluid. Pipeline systems play a vital role in distributing water, oil, gas, and other fluids to cities, industries, and various applications. However, these systems are susceptible to leaks, which can result in significant resource losses, environmental damage, and potential safety hazards. The leak detection system 100 utilizes hydraulic transport and machine learning techniques to accurately locate and size multiple leaks simultaneously in complex pipeline networks. Although the leak detection system 100 primarily focuses on water, it can be applied to any pressurized fluid-filled pipe system be it Gas, Water, or any other fluid. The leak detection system 100 employs a combination of hardware components and software algorithms to detect leaks in pressurized pipelines. The leak detection system 100 of the present disclosure is designed to be non-intrusive, efficient, and adaptable to various pipeline configurations, including complex networks with multiple interconnected pipes. The leak detection system 100 aims to reduce non-revenue water losses, conserve energy, and minimize the financial and environmental impacts associated with undetected leaks in pipeline infrastructure.

In particular, FIG. 1 illustrates the leak detection system 100 implemented as a mobile unit. In this configuration, the leak detection system 100 is adapted to be, at least partially, installed in a vehicle, facilitating on-site analysis and leak detection capabilities for various locations along the pipeline network. It may be appreciated that while the leak detection system 100 has been described in the context of a vehicle-mounted, mobile implementation for local detection, it should be understood that in other examples, the leak detection system 100 may be adapted to other forms. For example, the leak detection system 100 may be implemented as a stationary unit permanently installed at critical points in a pipeline network, or as a portable device that can be manually carried and set up at different locations. In other examples, the leak detection system 100 may be integrated directly into existing pipeline infrastructure, utilizing pre-installed pressure sensors and valves. Alternatively, the leak detection system 100 may be adapted for remote operation, with data collection and transmission handled by local sensing units, while analysis and visualization are performed at a centralized location, without departing from the spirit and the scope of the present disclosure.

As illustrated in FIG. 1, the leak detection system 100 includes a valve 110 located at an output port 12 of the pipeline system 10 for perturbing a pressure head in the fluid in response to a valve closure by the valve 110. In aspects of the present disclosure, the valve 110 is typically a shut-off valve that can be operated to create a sudden change in flow, generating a transient pressure wave within the pipeline system 10. This transient wave propagates through the fluid and interacts with any leaks or anomalies present in the pipeline system 10, creating reflected waves that carry information about the leaks. The valve 110 may be manually operated or automated, depending on the specific implementation of the leak detection system 100. The output port 12 where the valve 110 is located can be a fire hydrant, a dedicated testing port, or any other suitable access point to the pipeline system 10 that provides for controlled perturbation of the fluid pressure. The ability of the valve 110 to create controlled disturbances in the fluid flow facilitates the leak detection system 100 to actively probe the pipeline system 10 for leaks, rather than passively waiting for leaks or anomalies to manifest.

These transient waves are susceptible to various types of anomalies/defects, and their interactions, particularly reflections, depend on the specific characteristics of each defect. For example, a leakage defect interacting with an incoming wave of positive amplitude results in a negative reflection. In contrast, a partial blockage produces a positive reflection. Extended blockages, which are longer than the wavelength of the incident wave, generate both a positive reflection from the first edge and a negative reflection from the second edge. Additionally, wall thinning causes a negative reflection if its extent is shorter than the wavelength of the incoming wave. If the wall thinning is more substantial, it can produce two reflections: a negative reflection from the initial point and a positive reflection from the distal end.

The leak detection system 100 also includes a detachable pressure measurement device 120 for measuring a pressure head at the output port 12. The detachable pressure measurement device 120 is designed to accurately capture the transient pressure signals generated by the valve closure. The detachable nature of the pressure measurement device 120 provides flexibility in deployment and maintenance, enabling the leak detection system 100 to be easily installed at various locations along the pipeline system 10. The detachable pressure measurement device 120 includes a pressure monitoring device 122, which is the primary sensor responsible for converting the fluid pressure into measurable electrical signals. The pressure monitoring device 122 may utilize various pressure sensing technologies such as piezoelectric, capacitive, or strain gauge-based sensors, depending on the specific requirements of the application.

The leak detection system 100 can further include a connection adapter 124, which serves as an interface between the pipeline system 10 and the pressure monitoring device 122. One end of the connection adapter 124 is detachably connected to the output port 12 of the pipeline system 10. This detachable connection facilitates easy installation and removal of the leak detection system 100 without requiring permanent modifications to the pipeline infrastructure. The other end of the connection adapter 124 includes a device port 126 for connecting the pressure monitoring device 122. This standardized interface provides compatibility between the connection adapter 124 and the pressure monitoring device 122, facilitating quick and secure attachment. In present configurations, the connection adapter 124 is one of multiple interchangeable connection adapters with different inner diameters for connection to different types of output ports of various diameters. This configuration facilitates the connection of the leak detection system 100 to various types of output ports with different dimensions. This adaptability enhances the versatility of the leak detection system 100, allowing it to be used across a wide range of pipeline systems with varying specifications.

The leak detection system 100 further includes a signal acquisition unit 130 for acquiring a transient pressure head signal from the pressure measurement device 120. The signal acquisition unit 130 is configured for capturing, digitizing, and initially processing the analog signals generated by the pressure measurement device 120. For this purpose, the signal acquisition unit 130 typically includes analog-to-digital converters (ADCs) to transform the continuous analog pressure signals into discrete digital data that can be further analyzed (as discussed in the proceeding paragraphs). The signal acquisition unit 130 is configured to handle high sampling rates, typically set at 250 Hz or higher, to ensure accurate representation of the transient pressure waves propagating through the pipeline system 10. The transient pressure head signal, as acquired by the signal acquisition unit 130, includes a random noise. Such random noise may be inherent, and can originate from various sources such as flow turbulence, mechanical vibrations from flow regulation devices, fluctuations in consumer usage, environmental factors like proximity to highways or other infrastructure, and the like. The signal acquisition unit 130 may incorporate initial signal conditioning and filtering techniques to improve the signal-to-noise ratio before the data is passed for further analysis.

The leak detection system 100 further includes a neural network model 140 that maps the transient pressure head signal to an output leak function. The neural network model 140 is configured to process and analyze the acquired transient pressure head signals. The neural network model 140 can be implemented as a feedforward artificial neural network with multiple hidden layers. For instance, the neural network model 140 may include five hidden layers with 400, 400, 300, 300, and 200 neurons respectively (as discussed later in detail), although other configurations may be used depending on the specific requirements of the pipeline system 10. The output leak function, generated by the neural network model 140, is a probability density function that is proportional to a length of the pipeline system 10. This representation allows for the simultaneous detection and localization of multiple leaks along the entire length of the pipeline system 10. The output leak function is designed such that each potential leak point is represented by a density-like lobe, centered at a respective leak location, where an amplitude of peak indicates leak size and a position of the peak corresponds to the leak location.

Herein, a dimension of the output leak function is a fixed dimension of an output layer of the neural network model 140 that is independent of a number of leaks. This fixed-dimension output allows the leak detection system 100 to handle scenarios with varying numbers of leaks without requiring changes to architecture of the neural network model 140. That is, whether there is one leak, multiple leaks, or no leaks present, the output layer of the neural network model 140 maintains a fixed size. This approach facilitates the leak detection system 100 to adapt to different leak scenarios without the need for multiple specialized models or dynamic resizing of the network output. The fixed dimension of the output layer is typically set to a value that provides sufficient resolution to represent the entire length of the pipeline system 10, such as 101 features (as discussed later in detail) representing discrete points along a length of the pipeline system 10.

In aspects of the present disclosure, the neural network model 140 outputs the output leak function in which a standard deviation of the lobe is proportional to wavelength of the acquired transient pressure head signal. This relationship between the standard deviation of the lobe and the wavelength of the transient signal facilitates the leak detection system 100 to represent and localize leaks. Herein, the wavelength of the transient pressure head signal is determined by the characteristics of the valve closure and the properties of the pipeline system 10, such as the wave speed in the fluid. The wavelength can be calculated as: λ=a₀×T_{c}, where a₀ is the wave speed in the pipeline and T_{c} is the valve closure time. In the leak detection system 100, the standard deviation of each lobe in the output leak function is set to σ=λ/(2\sqrt{2 ln(20)}). This proportional relationship ensures that the width of each leak signature lobe in the output function is consistent with the resolution capabilities of the transient-based detection method. Leaks that are closer together than this width may be difficult to distinguish as separate entities. This approach allows the leak detection system 100 to adapt to different operational conditions, such as variations in valve closure time, which affect the injected signal wavelength and consequently the achievable spatial resolution of leak detection.

In an aspect of the leak detection system 100, with the valve 110 being a shut-off valve, the neural network model 140 is calibrated to accommodate for variability of closure time of the shut-off valve 110. As discussed, the shut-off valve 110 is designed to rapidly close, generating pressure transients in the pipeline system 10. However, the actual closure time of the shut-off valve 110 can vary due to mechanical factors, wear, or operational conditions. To address this, the neural network model 140 is trained on a dataset that includes simulations with varying valve closure times, typically ranging from 0.02 to 0.08 seconds (as discussed later in detail). This calibration ensures that the leak detection system 100 can accurately interpret transient signals generated by valve closures across this range, maintaining detection accuracy despite variations in the shut-off valve 110 performance.

In an aspect of the leak detection system 100, with the valve 110 being a shut-off valve, the neural network model 140 is calibrated to accommodate for variations in pre-transient flow rate at the valve location. The pre-transient flow rate at the location of the shut-off valve 110 can vary due to changes in consumer demand, time of day, or other operational factors. These variations affect the amplitude of the incident wave through Joukowsky's pressure head, defined as H_{J}=(a₀ Q_{0,v})/(gA), where a₀ is the wave speed, Q_{0,v} is the pre-transient flow rate, g is gravitational acceleration, and A is the pipe cross-sectional area. The neural network model 140 is calibrated using a dataset that includes scenarios with pre-transient flow rates varying from 1 to 3 liters per second (as discussed later in detail). This calibration facilitates the leak detection system 100 to accurately interpret transient signals and detect leaks across a range of operational flow conditions, enhancing its applicability in dynamic pipeline systems.

In an aspect of the leak detection system 100, with the valve 110 being a shut-off valve, the neural network model 140 is calibrated to accommodate for a combined variability of valve closure time and a pre-transient flowrate. This calibration addresses the relationship between valve closure time and pre-transient flow rate, both of which significantly influence the characteristics of the generated transient waves. The neural network model 140 is trained on a dataset that simultaneously varies both parameters, i.e., valve closure times ranging from 0.02 to 0.08 seconds and pre-transient flow rates from 1 to 3 liters per second (as discussed later in detail). This approach facilitates the leak detection system 100 to maintain accuracy in diverse operational scenarios where both valve performance and flow conditions may fluctuate.

In an aspect of the leak detection system 100, with the valve 110 being a shut-off valve, the neural network model 140 is calibrated to accommodate for pre-transient pressure head in the pipeline system 10. The pre-transient pressure head in the pipeline system 10 can vary due to factors such as elevation changes, friction losses, or pressure management practices. These variations affect the baseline pressure from which transients are generated and propagated. To address this, the neural network model 140 is trained on a dataset that includes simulations with different pre-transient pressure head values, typically ranging from 30 to 50 meters of water column (as discussed later in detail). This calibration ensures that the leak detection system 100 can accurately interpret transient signals and detect leaks regardless of the initial pressure conditions in the pipeline system 10.

Further, as illustrated in FIG. 1, the leak detection system 100 includes a display 150 for displaying the output leak function from the neural network model 140 in conjunction with a drawing of the pipeline system 10 with indications for locations of the leaks. The display 150 is configured to provide a visual interface for interpreting the results of the leak detection analysis. In present examples, the display 150 may be implemented as a touchscreen interface on a portable device, a monitor in a control room, or any other suitable visualization hardware compatible with the leak detection system 100. The display 150 presents the output leak function as a graphical representation overlaid on a schematic of the pipeline system 10. This visual approach allows for quick and intuitive identification of leak locations along the length of the pipeline system 10.

The display 150 is configured to display the output leak function in which each potential leak point is represented by a density-like lobe, centered at a respective leak location (as discussed). These density-like lobes appear as bell-shaped curves or peaks on the output function graph. The center of each lobe corresponds to the estimated location of the leak along the pipeline system 10. This representation allows for clear visualization of multiple leaks, as each leak appears as a distinct lobe on the display 150. The width of each lobe is related to the spatial resolution of the leak detection system 100, which is influenced by the wavelength of the injected transient signal. Further, the display 150 is configured to display the output leak function in which a peak amplitude of the lobe indicates a leak size. The height or magnitude of each density-like lobe on the output function graph correlates directly with the estimated size of the leak at that location. Larger leaks are depicted by lobes with higher peak amplitudes, while smaller leaks appear as lobes with lower peak amplitudes. This facilitates users of the leak detection system 100 to quickly assess the location as well as the relative size of detected leaks, aiding with prioritization of repair efforts.

In an aspect of the present disclosure, the display 150 is configured to display the output leak function as a plot in which a horizontal axis is normalized against pipe length, and a vertical axis is normalized in relation to the pipeline system's cross-sectional area. This normalization approach ensures that the display 150 provides a consistent and comparable representation across different pipeline systems 10 of varying lengths and diameters. The horizontal axis typically ranges from 0 to 1, representing the relative position along the pipeline from start to end. The vertical axis is normalized to represent leak sizes as fractions of the cross-sectional area of the pipeline system 10, typically ranging from 0 to 0.01 or 1% of the pipe area. This normalized display format facilitates users to interpret leak locations and sizes in a standardized manner, regardless of the specific dimensions of the pipeline system 10 being analyzed.

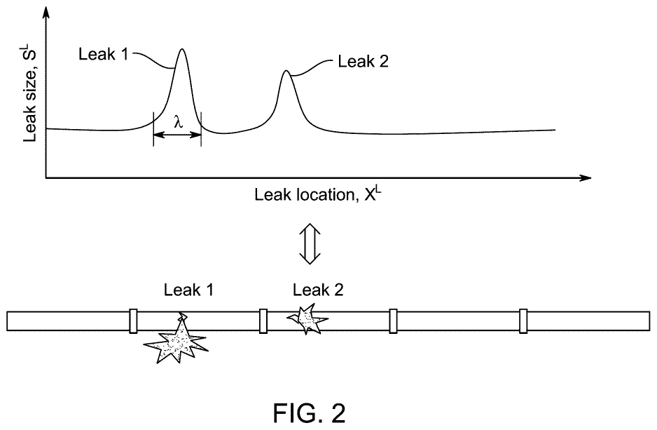

In general, the leak detection system 100 of the present disclosure provides a framework for detecting multiple leaks simultaneously using a single ML model, without constraining the target vector based on the number of leaks. The output functions of matched-field processing (MFP) are used to locate the source of a recorded wavefield [See: X. Wang, M. S. Ghidaoui, Pipeline leak localization using matched-field processing, Journal of Hydraulic Engineering 144 (6) (2018) 04018030, incorporated herein by reference in its entirety]. The time reversal method (TRM) [See: M. Waqar, M. Louati, M. S. Ghidaoui, Time-reversal technique for pipeline defect detection, Water research 243 (2023) 120375, incorporated herein by reference in its entirety] is a method for detecting defects in pressurized pipelines using active transient waves. It's based on the one-dimensional wave equation and can be used to detect discrete defects like leaks and blockages. In both cases, the output is a function. It has been determined that the output of the neural network can be a function that isa fixed dimension regardless of the number of leaks. In this function, each potential leak point is represented by a density-like lobe, with its width proportional to the wavelength of the transient signal injected into the system. FIG. 2 demonstrates the lobe, centered at location of the leak, with its width proportional to the wavelength of the transient signal injected into the system. Mathematically, this output function is described as:

$$\\ \begin{matrix}ℒ ( {x}^{L} , {s}^{L} , {n}^{L} ) = {\sum }_{i = 1}^{{n}^{L}} {s}_{i}^{L} \cdot exp ( - \frac{{( x - {x}_{i}^{L} )}^{2}}{2 {σ}^{2}} ) & ( 6 )\end{matrix}$$

where [symbol] (x^{L},s^{L},n^{L}) is the leak function,

$$\\ {x}_{i}^{L}$$

denotes a peak in the function, indicating the location of the i-th leak, σ=λ/(2\sqrt{2 ln(20)}) translates to the standard deviation of the peak, λ is the wavelength of the signal, and

$$\\ {s}_{i}^{L}$$

is the peak magnitude of the lobe, representing the i-th leak size. As such, the former framework in equation (5) is redefined as:

$$\\ \begin{matrix}\hat{ℒ} ( {x}^{L} , {s}^{L} , {n}^{L} ) = ML ( {h}_{m} ( t , {x}^{L} , {s}^{L} , {n}^{L} ) ) & ( 7 )\end{matrix}$$

where [symbol] (\hat{x}^{L},ŝ^{L},\hat{n}^{L}) is an estimate of [symbol] (x^{L},s^{L},n^{L}).

Thereby, the leak detection system 100 of the present disclosure addresses limitations of conventional approaches through its design. The neural network model 140 of the leak detection system 100 predicts an output leak function that indirectly represents leak properties, enabling training across scenarios with different numbers of leaks. This approach provides flexibility to the leak detection system 100, reducing discrepancies between the number of leaks in training data and actual scenarios, and the actual number of leaks and is limited only by the maximum number used in training. The leak detection system 100 ensures that the dimension of the output leak function remains fixed regardless of the number of leaks present. This fixed-dimension output allows the neural network model 140 of the leak detection system 100 to be fine-tuned to accommodate model uncertainties or to handle a higher number of leaks without requiring a complete retraining of the model, which enhances the adaptability and efficiency of the leak detection system 100 in various operational scenarios.

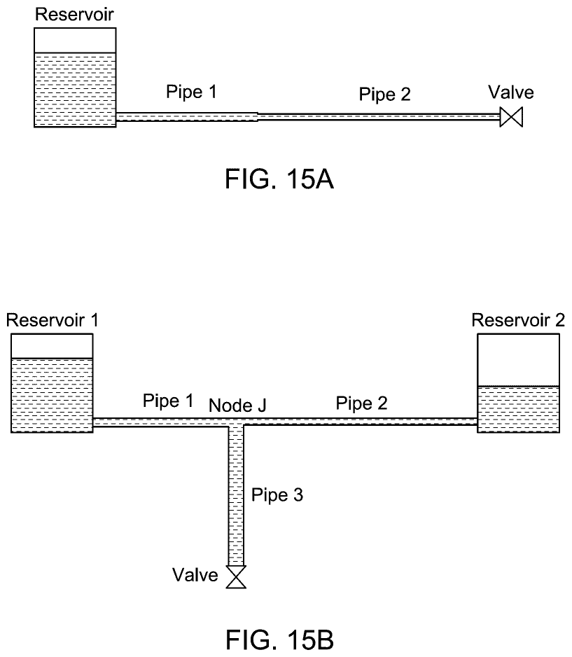

In some examples, the pipeline system 10 is a pipe-in-series system (as illustrated in FIG. 15A, and discussed later in more detail) with two pipes connected in series. This configuration consists of two pipes of potentially different lengths and diameters connected end-to-end. The leak detection system 100 is adapted to handle this series configuration by treating the entire length as a continuous pipeline while accounting for the changes in pipe characteristics at the junction. The neural network model 140 can be trained on datasets that include simulations of leaks in both pipes, allowing the leak detection system 100 to accurately localize and size leaks along the entire length of the series pipeline system 10.

In other examples, the pipeline system 10 is a tree-type network (as illustrated in FIG. 15B, and discussed later in more detail) having three or more connected pipes. This configuration represents a more complex pipeline topology commonly found in real-world distribution systems. For example, the tree-type network might consist of a main pipe branching into two or more secondary pipes, each potentially having different lengths and diameters. The leak detection system 100 is adapted to handle such complex configurations by configuring the neural network model 140 to process signals from multiple measurement points and generate an output leak function that covers all branches of the network. The training data for the neural network model 140 includes simulations of various leak scenarios across all pipes in the tree-type network, enabling the leak detection system 100 to detect and localize leaks in any part of such complex pipeline system.

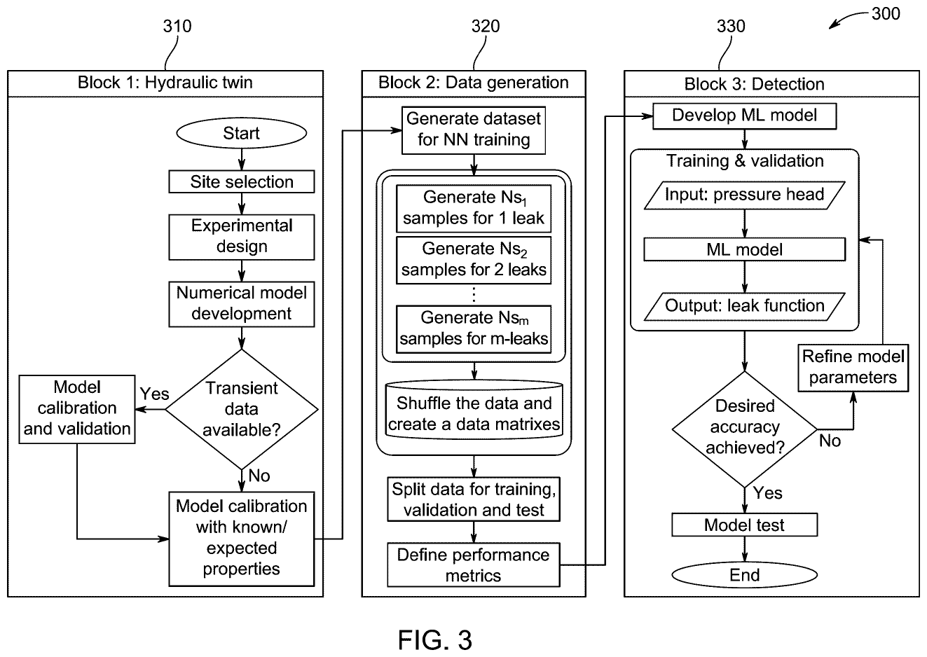

FIG. 3 is an exemplary flowchart illustrating a process (as represented by reference numeral 300) for developing and validating a machine learning model for leak detection in the leak detection system 100. The process 300 is divided into three main blocks, namely a block 310 for development of the hydraulic twin model, a block 320 for data generation, and a block 330 for leak detection. This approach ensures that the leak detection system 100 is built on a strong foundation of accurate hydraulic modeling, extensive data generation, and well-trained machine learning algorithms, enabling effective detection of multiple simultaneous leaks in complex pipeline systems.

The process 300 begins at the block 310 with site selection for the real pipeline system 10 to be modeled as the hydraulic twin, followed by experimental design. This includes identifying access locations, understanding pipeline geometry, and defining operational conditions such as flow rates, pressure heads, consumer demands, locations for transient generation, and sensor installation. The next step involves numerical model development, creating a virtual and hydraulic transient twin of the real pipeline system. If transient data is available, the model undergoes calibration and validation. If not, the model is calibrated with known or expected properties of hydraulic flow. Calibration involves adjusting parameters such as excited wave amplitude, waveforms, wave speed, and damping factors.

At the block 320, the process 300 focuses on data generation for training the neural network model 140. Using the calibrated hydraulic transient twin model, the process generates a dataset for neural network training. This involves simulating transient responses for varying numbers and sizes of leaks. As illustrated, the process 300 involves generating N₁ samples for 1 leak, N₂ samples for 2 leaks, up to Nₘ samples for m-leaks. The number of samples per leak scenario depends on computational complexity and engineering discretion. It is recommended to start with simulations for small SNR values, as smaller leaks are more challenging to detect. Leak locations can vary between λ and L−λ, where L is the pipe length and λ is the wavelength of the injected transient signal. For post-simulation, the defect information (leak size, location, and number) for each sample is transformed into a leak function, as described in equation (6). This forms the basis of the disclosed framework, where the ML model maps the measured transient response to the corresponding leak function, which could have 1, 2, or n^{L} peaks. Herein, after generation, the data is shuffled and organized into matrices. The data set is then split for training, validation, and testing purposes. Also, performance metrics for evaluating the model are defined in the block 320.

At the block 330, the development and refinement of the machine learning model, specifically the neural network model 140, is constructed. Herein, the process 300 involves developing the initial machine learning model structure. The training and validation loop is illustrated, where the input is the pressure head data, and the output is the leak function. If the desired accuracy is not achieved, the model parameters are refined, and the process iterates. Once the desired accuracy is reached, the model undergoes final testing. This block emphasizes the iterative nature of model development and the importance of continuous refinement to achieve optimal leak detection performance in the leak detection system 100. In the block 330, a regression-based ML model is developed. The input to this model is the measured pressure head (hₘ(t,x^{L},s^{L},n^{L})), while the output is the leak function ( [symbol] (x^{L},s^{L},n^{L})). As noted above, s^{L} denotes the leak size, x^{L} is the leak location, n^{L} is the number of leaks, t denotes the time vector, n is the noise. The present disclosure utilizes an Artificial Neural Network (ANN) as a surrogate model for this mapping, although the process is applicable to other machine learning models. The simulated data is split into training, validation, and testing segments. For testing purposes, a new dataset can be generated from the calibrated hydraulic model. Moreover, the training dataset with different number of leaks can be simulated and used simultaneously for ML model training.

To evaluate the effectiveness of the regression model, several parameters including Mean Squared Error (MSE), Root Mean Squared Error (RMSE), Mean Absolute Error (MAE), R² (R-square), and Pearson Correlation Coefficient (PCC) are utilized [See: G. James, D. Witten, T. Hastie, R. Tibshirani, et al., An introduction to statistical learning, Vol. 112, Springer, 2013, incorporated herein by reference in its entirety]. Ideally, MSE, RMSE, and MAE are error metrics that should be minimized; thus, lower values directly correlate to better model performance. There are no upper bounds for these three indicators; they can range from 0 to infinity, where 0 represents a perfect fit to the data. On the other hand, PCC and R² are bounded metrics where higher values indicate better performance. The PCC has a range from −1 to 1, with 1 being a perfect positive linear correlation, 0 indicating no correlation, and −1 signifying a perfect negative linear correlation. The R² metric is bounded between 0 and 1, where 1 indicates that the model explains all the variability of the target variable around its mean, and 0 implies that the model fails to capture any of the variance of the target variable.

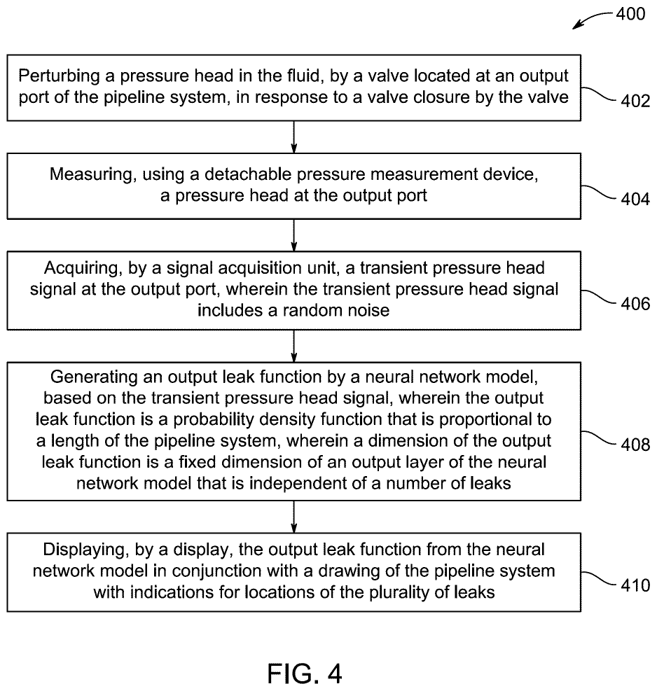

Referring to FIG. 4, the present disclosure further provides a method (as represented by a flowchart, referred by reference numeral 400) for detecting multiple simultaneous leaks within a pipeline system (such as, the pipeline system 10) that transports a fluid. The method 400 is performed using a neural network model as developed using the process in FIG. 3 and includes a series of steps. These steps are only illustrative, and other alternatives may be considered where one or more steps are added, one or more steps are removed, or one or more steps are provided in a different sequence without departing from the scope of the present disclosure. The method 400 is designed to operate in conjunction with the leak detection system 100. Various variants disclosed above, with respect to the aforementioned leak detection system 100 apply as well to the present method 400.

At step 402, the method 400 includes perturbing a pressure head in the fluid, by the valve 110 located at the output port 12 of the pipeline system 10, in response to a valve closure by the valve 110. This step involves the controlled closure of the valve 110, typically a shut-off valve, to generate a pressure transient within the pipeline system 10. The closure time of the valve 110 is an important parameter that affects the characteristics of the generated transient waves. This perturbation creates pressure waves that propagate through the fluid in the pipeline system 10, interacting with any leaks present.

At step 404, the method 400 includes measuring, using the detachable pressure measurement device 120, a pressure head at the output port 12. The detachable pressure measurement device 120 captures the pressure fluctuations resulting from the valve closure and subsequent wave propagation. The pressure measurement device 120 can include a pressure monitoring device 122 connected via a connection adapter 124 to the output port 12. The detachable nature of the pressure measurement device 120 allows for flexibility in deployment at various locations along the pipeline system 10.

At step 406, the method 400 includes acquiring, by the signal acquisition unit 130, the transient pressure head signal at the output port 12. Herein, the transient pressure head signal includes a random noise, due to various sources. The signal acquisition unit 130 digitizes and initially processes the analog signals from the pressure measurement device 120. The acquired transient pressure head signal inherently contains the random noise from various sources such as flow turbulence, mechanical vibrations, and environmental factors. The signal acquisition unit 130 is configured to handle high sampling rates, such as 500 or more samples per second, to ensure accurate representation of the transient pressure waves propagating through the pipeline system 10.

At step 408, the method 400 includes generating an output leak function by the neural network model 140, based on the transient pressure head signal. The neural network model 140 processes the acquired transient pressure head signal to produce the output leak function. Herein, the output leak function is a probability density function that is proportional to a length of the pipeline system 10. Further, the dimension of the output leak function is a fixed dimension of an output layer of the neural network model 140 that is independent of a number of leaks (i.e., this dimension remains constant regardless of the number of leaks present in the pipeline system 10). As mentioned above, this fixed-dimension approach allows the method 400 to detect and localize multiple leaks simultaneously without requiring changes to the neural network architecture. The output leak function represents each potential leak point as a density-like lobe, where the amplitude of the peak indicates the leak size, the position of the peak corresponds to the leak location, and the standard deviation is relative to the wavelength of the injected transient signal.

At step 410, the method 400 includes displaying, by the display 150, the output leak function from the neural network model 140 in conjunction with a drawing of the pipeline system 10 with indications for locations of the multiple leaks. The display 150 presents the output leak function as a graphical representation overlaid on a schematic of the pipeline system 10. This visual approach allows for quick and intuitive identification of leak locations and sizes along the length of the pipeline system 10. In one embodiment, the locations of the leaks can be indicated by a length value based on a distance measurement from an end of the pipeline system that the pressure measurement device is attached to. The length can be indicated in a regular dimension, such as meters, yards, or feet. Subsequently, the method 400 provides a clear and interpretable visualization of the leak detection results, facilitating rapid assessment and decision-making regarding leak locations and severities in the pipeline system 10.

Herein, the displaying, in the method 400, includes displaying the output leak function in which each potential leak point is represented by the density-like lobe, centered at a respective leak location. This representation on the display 150 allows for clear visualization of multiple leaks along the pipeline system 10. Each lobe appears as a bell-shaped curve or peak on the output function graph, with the center of each lobe corresponding to the estimated location of a leak along the pipeline system 10.

Further, the displaying, in the method 400, includes displaying the output leak function in which a peak amplitude of the lobe indicates a leak size. That is, in the display 150, the height or magnitude of each density-like lobe on the output function graph correlates directly with the estimated size of the leak at that location. Larger leaks are depicted by lobes with higher peak amplitudes, while smaller leaks appear as lobes with lower peak amplitudes. This feature allows users to quickly assess not only the location but also the relative severity of detected leaks.

Further, in the method 400, generating, by the neural network model 140, includes generating the output leak function in which a standard deviation of the lobe is proportional to wavelength of the acquired transient pressure head signal. This proportional relationship ensures that the width of each leak signature lobe in the output function is consistent with the resolution capabilities of the transient-based detection method used in the leak detection system 100.

Further, the displaying, in the method 400, displays the output leak function as a plot in which a horizontal axis is normalized against pipe length, and a vertical axis is normalized in relation to the pipeline system's cross-sectional area. This normalization approach on the display 150 ensures a consistent and comparable representation across different pipeline systems of varying lengths and diameters. The horizontal axis typically ranges from 0 to 1, representing the relative position along the pipeline from start to end. The vertical axis is normalized to represent leak sizes as fractions of the pipeline system's cross-sectional area, typically ranging from 0 to 0.01 or 1% of the pipe area. This normalized display format facilitates users to interpret leak locations and sizes in a standardized manner, regardless of the specific dimensions of the pipeline system 10 being analyzed.

Herein, the output port 12 is configured with the shut-off valve 110, and the method 400 further includes calibrating the neural network model 140 to accommodate for variability of valve closure time. This calibration process involves training the neural network model 140 on a dataset that includes simulations with varying valve closure times. The method 400, by incorporating this variability into the training data, ensures that the leak detection system 100 can accurately interpret transient signals generated by valve closures. This calibration step enhances applicability of the method 400 in real-world scenarios where precise control of valve closure may be a challenge due to mechanical factors, wear, or operational conditions.

Further, the output port 12 is configured with the shut-off valve 110, and the method 400 further comprises calibrating the neural network model 140 to accommodate for variations in a pre-transient flow rate at the valve location. This calibration step addresses the fact that pre-transient flow rates at the location of the shut-off valve 110 can vary due to changes in consumer demand, time of day, or other operational factors. The method 400 includes training the neural network model 140 using a dataset that incorporates scenarios with pre-transient flow rates. This calibration step facilitates the method 400 to accurately interpret transient signals and detect leaks across a range of operational flow conditions.

Further, the output port 12 is configured with the shut-off valve 110, and the method 400 further includes calibrating the neural network model 140 to accommodate for a combined variability of valve closure time and a pre-transient flowrate. This calibration step addresses the relationship between valve closure time and pre-transient flow rate. The method 400 includes training the neural network model 140 on a dataset that simultaneously varies both valve closure time and pre-transient flow rate. This approach facilitates the method 400 to maintain accuracy in diverse operational scenarios where both valve performance and flow conditions may fluctuate, enhancing its adaptability to actual pipeline conditions where multiple variables may change concurrently.

### EXPERIMENTAL PART

The following paragraphs provide a detailed numerical analysis of the leak detection system 100 and the method 400 of the present disclosure, demonstrating the effectiveness in detecting multiple simultaneous leaks within various pipeline configurations. This analysis includes the generation of training datasets, the development and optimization of the neural network model 140, and the evaluation of performance of the leak detection system 100 under different operational conditions. The numerical examples presented herein illustrate the capabilities of the leak detection system 100 in handling complex scenarios, including variations in valve closure time, pre-transient flow rates, and pipeline network topologies. These examples showcase the adaptability of the leak detection system 100 and the method 400 in real-world applications, from simple single-pipe systems to more intricate tree-type networks with multiple interconnected pipes.

The leak detection system 100 can be evaluated using a numerical simulation of a reservoir-pipeline-valve system. The system comprises a 500 m long pipe with an internal diameter of 150 mm and a wall thickness of 5 mm. The pipeline is modeled as an elastic structure characterized by a Young's modulus of 170 GPa and a Darcy-Weisbach friction factor of 0.015. Under these conditions, the transient wave speed, denoted as a₀, is calculated to be 1.25 km/s. The system operated with a pre-transient flow rate of 2 LPS and a pressure head of 40 m at the downstream valve. This configuration results in a Joukowsky pressure head (H_{J}) of approximately 14.4 m above the steady-state pressure head.

For the simulation, 3 wave periods can be considered, equating to a total time of T=12×L/a₀=4.796 seconds. A sampling frequency of Fₛ=250 Hz is utilized, yielding 1200 data points for each transient signal. The spatial resolution of the simulation is set to Δx=4.9783 m, allowing for a minimum distance of Δx between two potential leaks. The transient wave was initiated by a valve maneuver with a closure time of T_{c}=0.03 s, resulting in a minimum wavelength λₘᵢₙ=a₀×T_{c}=37.3 m for the injected transient wave. Consequently, the diffraction limit is approximately λₘᵢₙ/2=18.67 m. The transient signals recorded at the valve location are utilized for the development of the neural network model 140.

To simulate leaks, leak sizes and locations can be randomly chosen from a uniform distribution. Leak sizes range between (0,0.01Aₚ), where Aₚ is the cross-sectional area of the pipe, and leak locations are selected within the bounds of [λ, L−λ]. The datasets included scenarios of 1, 2, and 3 leaks, each simulated 2000 times, resulting in a total of 6000 samples. Each sample comprises 1200 data points representing the pressure head. Every measured pressure head signal is then corrupted by adding noise. The simulated noise is sampled from a Gaussian distribution with 0 mean and standard deviation of σₙₒᵢₛₑ, calculated from equation (3) as:

$$\\ \begin{matrix}{σ}_{noise} = Δ {h}_{L} \times {10}^{- SNR / 20} & ( 8 )\end{matrix}$$

where Δh_{L} is the leak-induced pressure head difference, and SNR=10 is chosen for illustration purposes.

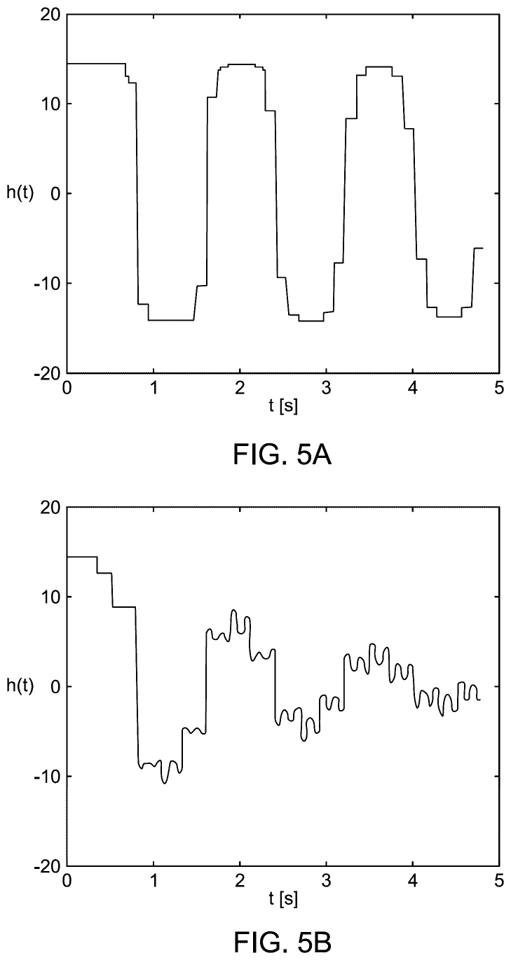

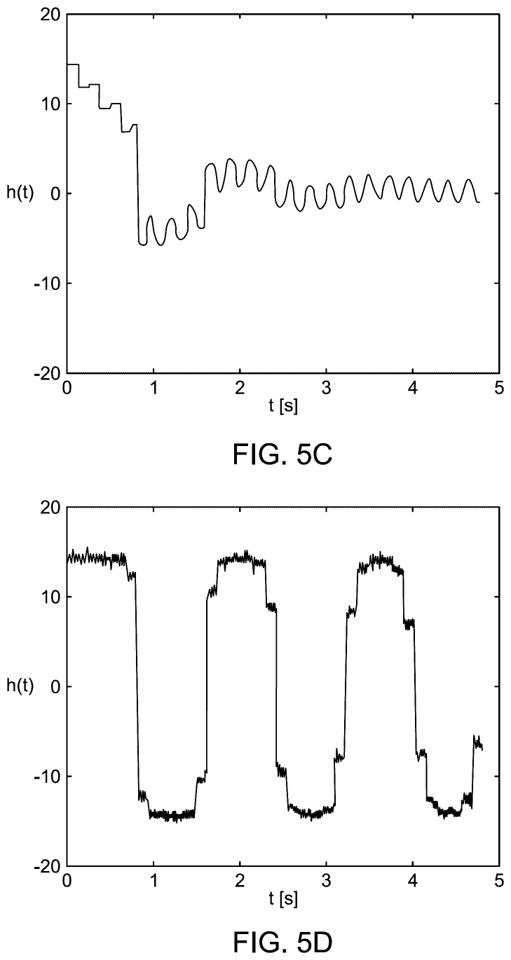

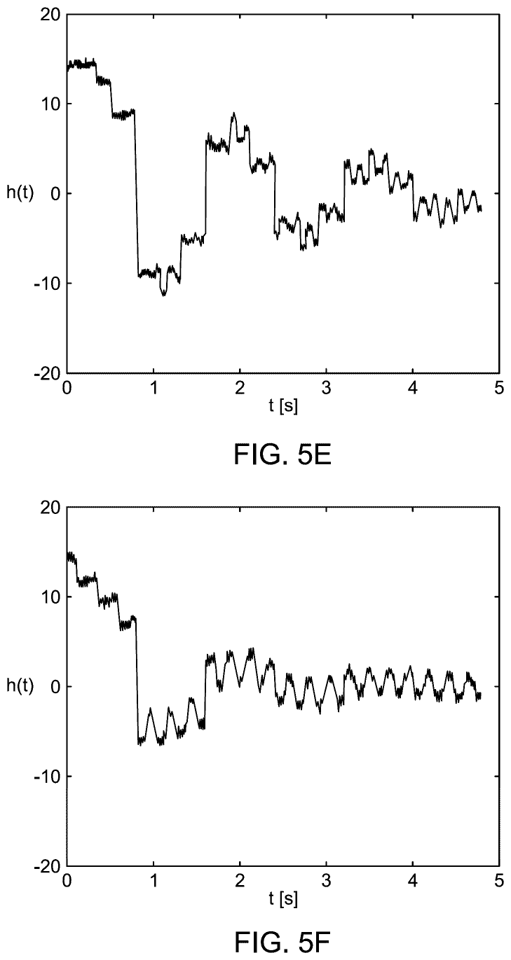

FIGS. 5A-5F provide illustrative examples of transient signals for scenarios involving single, double, and triple leaks, each randomly selected from the dataset. In these plots, the horizontal axes represented the time and vertical axes denoted the perturbed pressure head in response to the valve maneuver. These figures provide visual representations of the transient pressure head signals that serve as input to the neural network model 140. FIG. 5A, FIG. 5B, and FIG. 5C show the numerically simulated signals without noise for one leak, two leak, and three leak scenarios, respectively. The clean signals in these figures demonstrate the characteristic pressure wave reflections caused by leaks in the pipeline system 10. FIG. 5D, FIG. 5E, and FIG. 5F depict the same scenarios but with added noise, simulating real-world conditions. The noise in these signals is sampled from a Gaussian distribution with zero mean and a standard deviation calculated based on the leak-induced pressure head difference and a signal-to-noise ratio (SNR) of 10. This addition of noise to the simulated signals is utilized for training the neural network model 140 to handle real-world data effectively. The comparison between the noise-free and noisy signals across different leak scenarios demonstrates the challenge faced by the leak detection system 100 in extracting meaningful leak information from noisy measurements.

Data preprocessing is also an important aspect of the framework for the leak detection system 100. The transformation of pressure head signals, which serves as the input to the neural network model 140, is achieved by converting step-responses into pulse responses. This conversion involves subtracting a delayed copy of the original signals, a method outlined in [See: Lee P J (2005) Using system response functions of liquid pipelines for leak and blockage detection. Ph.D. thesis, incorporated herein by reference in its entirety]. Additionally, the leak properties, constituting the output of the neural network model 140, are represented through a leak function as defined in equation (6).

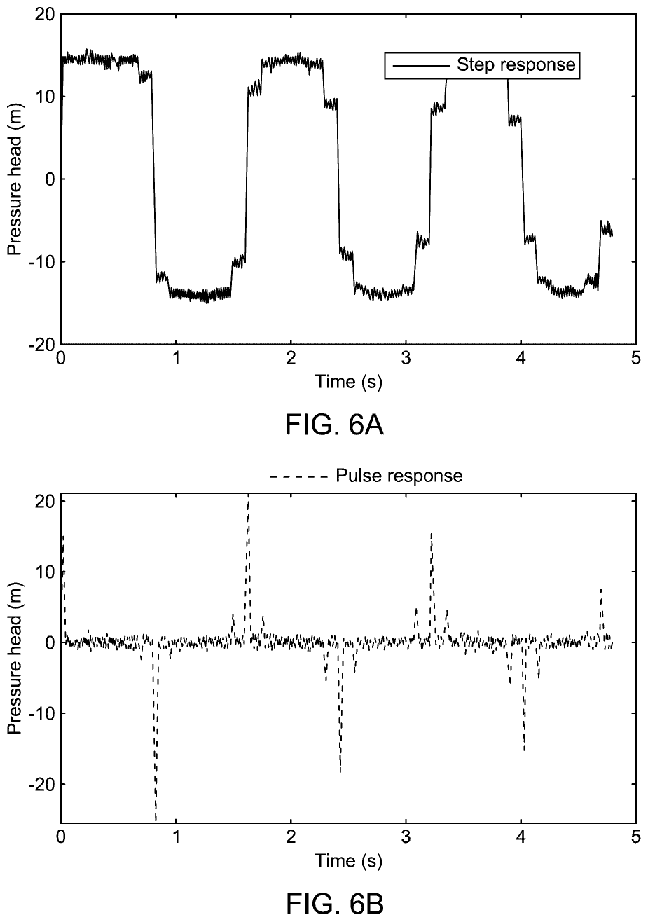

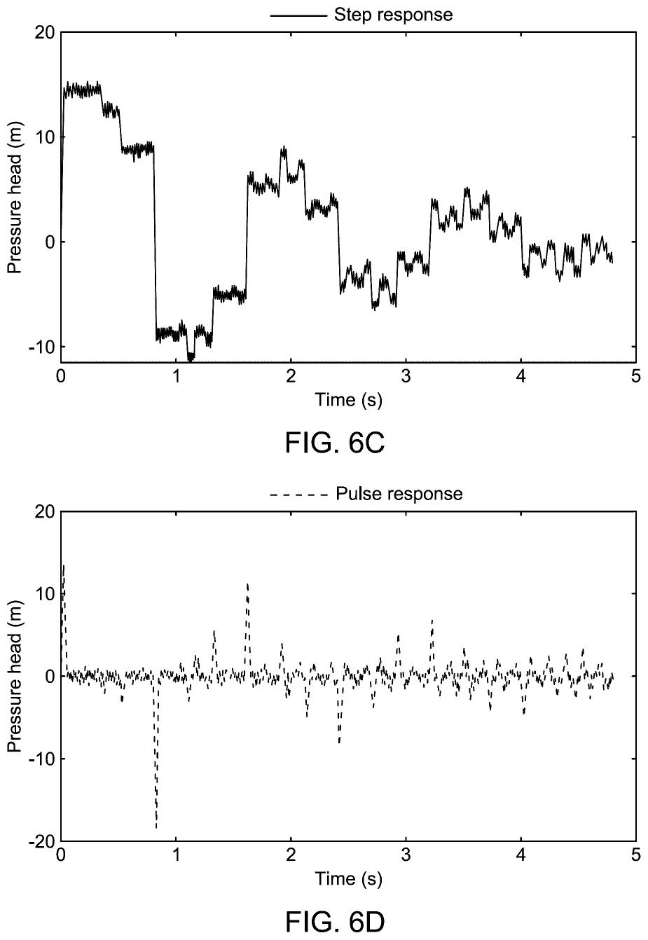

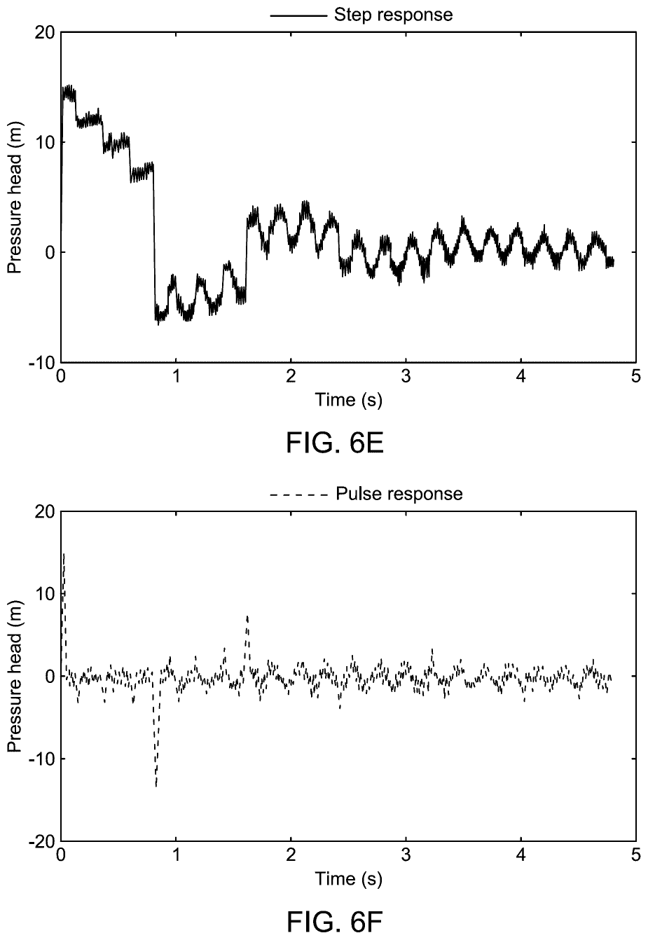

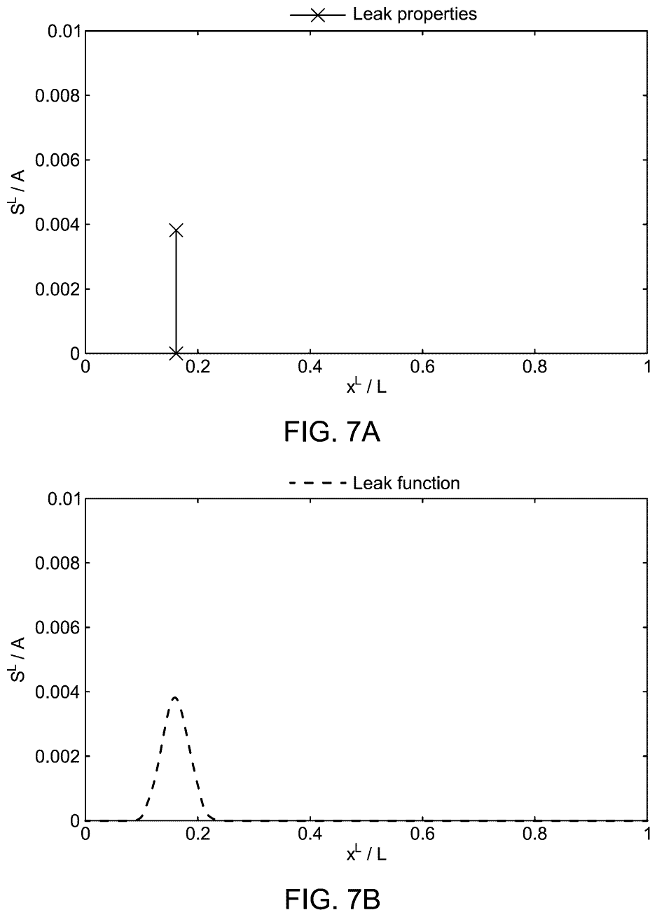

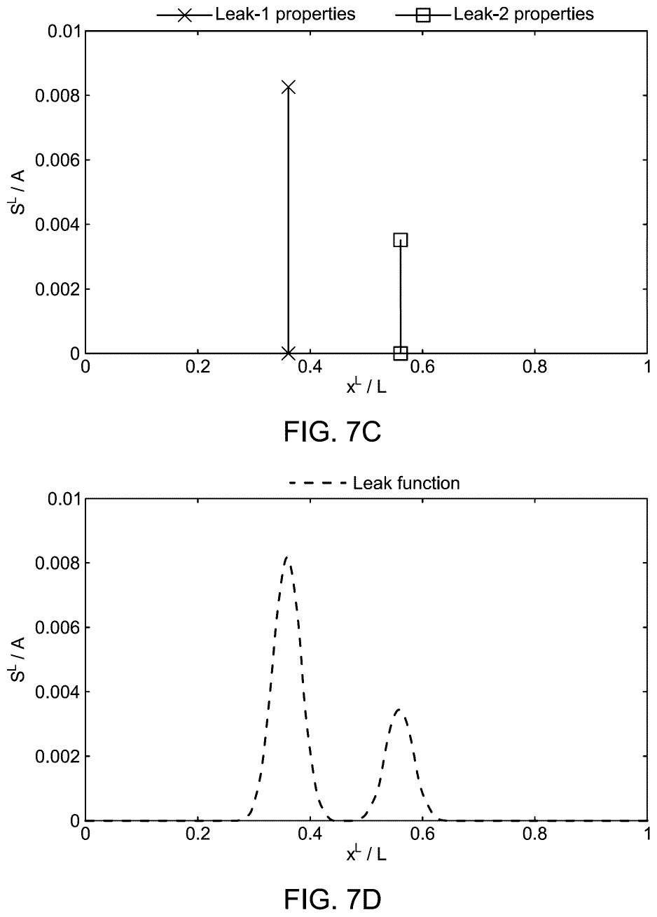

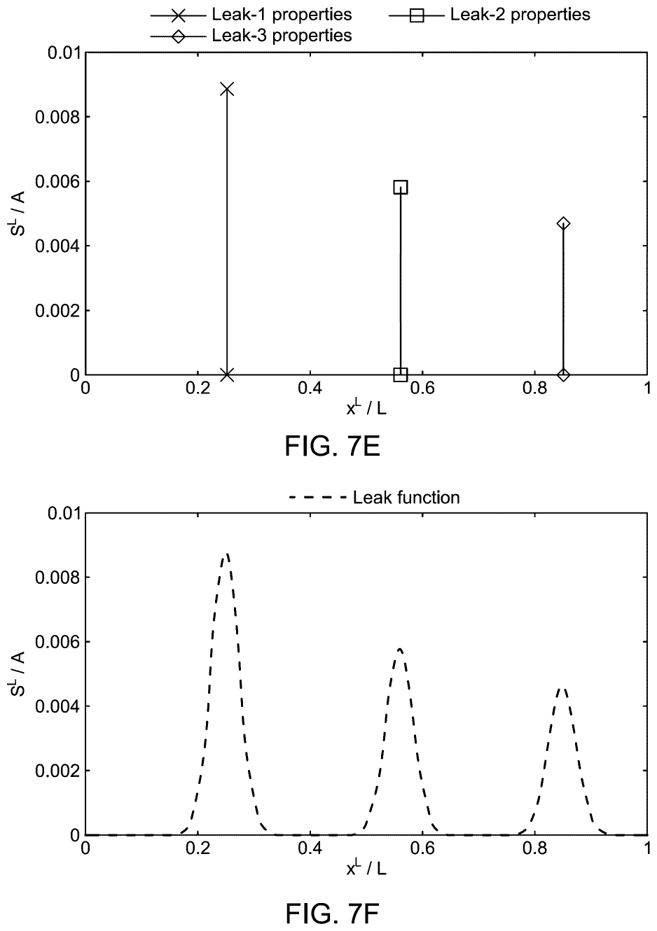

Illustrative examples of these transformations are presented in FIGS. 6A-6F and 7A-7F. FIGS. 6A-6F display the conversion of signals from step to pulse responses, while FIGS. 7A-7F depict the leak function for different leak scenarios (one, two, and three leaks). In particular, FIG. 6A, FIG. 6C, and FIG. 6E show the pressure-time signals in step response format for one, two, and three leak scenarios, respectively. FIG. 6B, FIG. 6D, and FIG. 6F depict the corresponding signals converted to pulse response format. This conversion is achieved by subtracting a delayed copy of the original signals, a method used for enhancing the correlation between input signals and their corresponding leak functions in the neural network model 140. The pulse response format accentuates the reflections caused by leaks, making them more distinct and easier for the neural network model 140 to identify. Further, FIG. 7A, FIG. 7C, and FIG. 7E show the numerically simulated leak properties in the hydraulic model for one, two, and three leak scenarios, respectively. These graphs represent the actual leak locations and sizes as simulated in the pipeline system 10. FIG. 7B, FIG. 7D, and FIG. 7F depict the corresponding leak functions for these scenarios. The leak function, as defined in the leak detection system 100, is a probability density function where each potential leak point is represented by a density-like lobe. In the latter plots, the horizontal axes were normalized against the pipe length, and the vertical axes were normalized in relation to cross-sectional area of the pipe. The rationale behind transforming the signals into pulse responses was that pulses reflecting from leaks correlated more strongly with their corresponding leak function than step-formatted reflections. This hypothesis is substantiated through the training of the optimized neural network model 140. It is observed that using pulse-type input signals yields higher accuracy compared to step-like signals.

For the neural network model 140, a feedforward neural network, a type of Artificial Neural Network (ANN), is employed. The structure and hyperparameters of the network are carefully optimized using a trial-and-error approach. This method ensures the fine-tuning of the model to best fit the specific requirements of the dataset. The optimized model network consists of five hidden layers with varying numbers of neurons, designed to capture complex data patterns. The layers are configured with 400, 400, 300, 300, and 200 neurons, respectively. Data splitting is strategically done with 70% for training, 20% for validation, and 10% for testing, to prevent over-fitting and ensure robust model evaluation. The training employs scaled conjugate gradient backpropagation (trainscg) optimizer, known for its low computational cost. The hidden layers use the tan-sigmoid function (tansig) as the activation function, effectively mapping input values between −1 and 1. The hyperparameters of the network are detailed in Table 1 below.

TABLE 1
Neural Network Hyperparameters

| Parameter | Value |
|---|---|
| Hidden layer sizes | 400, 400, 300, 300, 200 |
| Learning rate | 0.01 |
| Momentum constant | 0.9 |
| Maximum epochs | 30,000 |
| Performance goal | 1 × 10⁻⁵ |
| Validation fail count | 1000 |

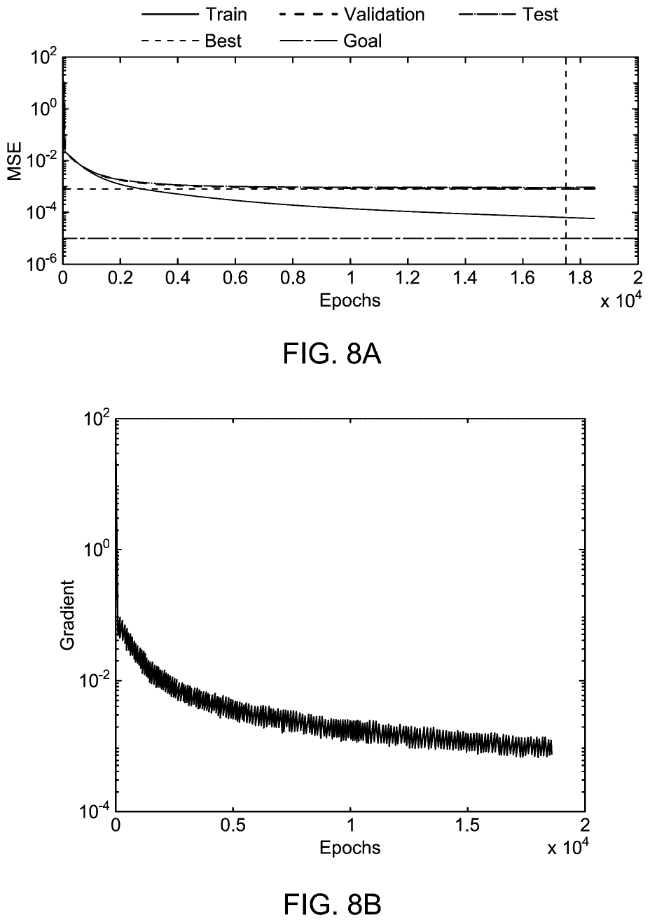

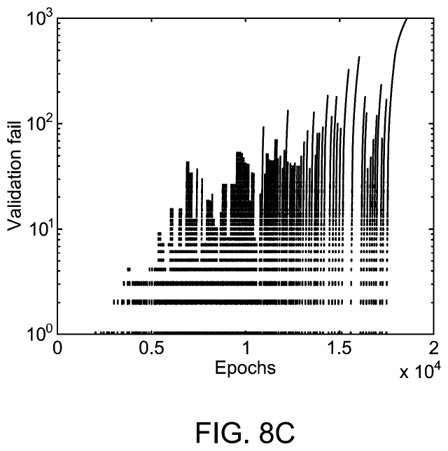

FIGS. 8A-8C illustrate three key aspects of the training dynamics for the neural network model 140. FIG. 8A presents the Mean Squared Error (MSE), which serves as the loss function for the neural network model 140, plotted over the number of epochs. The MSE tracks the average of the squares of the errors, i.e., the differences between the predicted and actual values. The training curve shows a decreasing trend, indicating learning and model improvement over time. Notably, the MSE for the validation set initially decreases alongside the training set, indicating that the neural network model 140 is generalizing well. The dashed ‘Best’ line marks the epoch at which the validation MSE is at its lowest, a potential candidate for model selection. The ‘Goal’ line represents the pre-defined performance goal, which the training process strives to achieve or surpass. FIG. 8B presents the gradient of the loss function with respect to the epochs. The magnitude of the gradient is used during training to update the model weights, with a descending trend reflecting the convergence of the neural network model 140 towards a minimum in the loss function. FIG. 8C presents the validation fails over epochs, which counts the number of consecutive epochs where the validation performance has not improved. The training of the neural network model 140 continues until this count reaches the pre-set maximum of 1000, as denoted by the threshold line. Spikes in the validation fail count are indicative of the difficulty of the neural network model 140 in further reducing validation error, potentially due to the complexity of the feature space or noise within the data. Once the validation fail count reaches 1000, training is halted to prevent over-fitting, as the lack of improvement in validation performance could imply that the neural network model 140 has learned the training data too closely.

The neural network model 140 is trained using a dataset consisting of 6000 samples, each with 1200 features, and the output layer corresponding to 6000 samples with 101 features each. The network architecture comprises an input layer, multiple hidden layers, and an output layer, amounting to a total of 972,101 trainable parameters. This level of complexity in the structure of the neural network model 140 allows for intricate pattern recognition and is managed within a training duration of 2 hours and 36 minutes on a computer processor. The training of the neural network model 140 is conducted using appropriate software and is completed on a CPU without the aid of GPU acceleration, highlighting the efficiency of the neural network model 140 on standard hardware configurations.

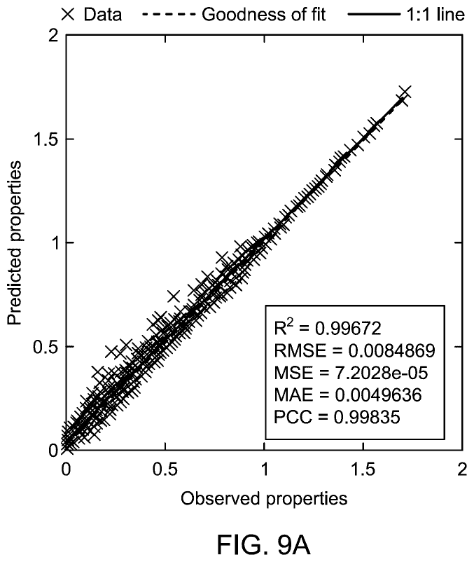

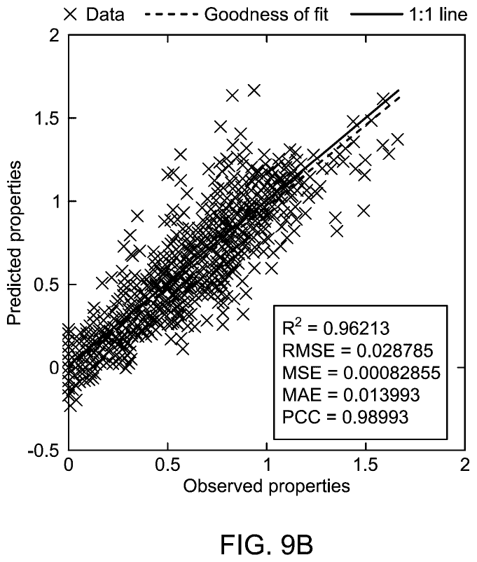

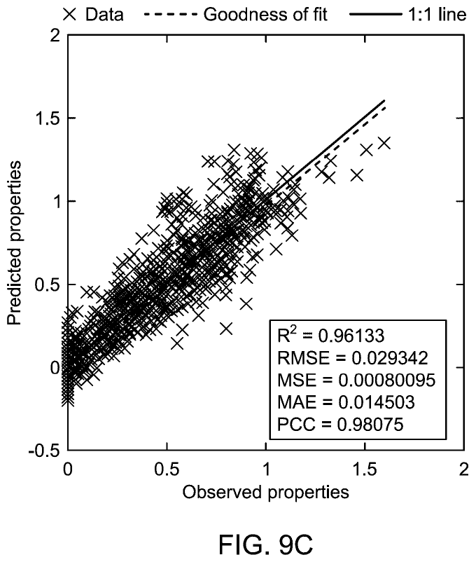

FIGS. 9A-9C present an overview of the predictive performance of the neural network model 140 across different datasets. The observed properties are plotted along the x-axis, and the predicted properties are on the y-axis. The crosses represent individual predictions, the dashed line shows the regression line indicating the goodness of fit, and the solid line depicts the ideal 1:1 relationship between observed and predicted values. Insets in each figure display the performance metrics of model, including R², RMSE, MSE, MAE, and PCC. FIG. 9A presents the performance on the training set, with an exceptional degree of fit as evidenced by the high R² value, indicating that the neural network model 140 has learned the training data effectively. The proximity of the data points to the 1:1 line indicate accurate predictions relative to the observed data. FIG. 9B presents the validation set, which is used to tune the hyperparameters of the neural network model 140. The plot shows a slightly wider dispersion of points compared to the training set, yet maintains a high R² value, indicating good generalizability of the neural network model 140 to unseen data. FIG. 9C presents the testing set, which assess the performance of the neural network model 140 on entirely new data. While there is a further increase in the spread of data points around the regression line, the R², RMSE, MSE, and MAE values confirm that the predictive accuracy of the neural network model 140 remains high. The PCC across all datasets remains robust, highlighting the consistent ability of the neural network model 140 to predict leak properties accurately. These results collectively demonstrate robustness and reliability of the ANN model in leak detection, from learning during training to generalizing well in validation and testing phases.

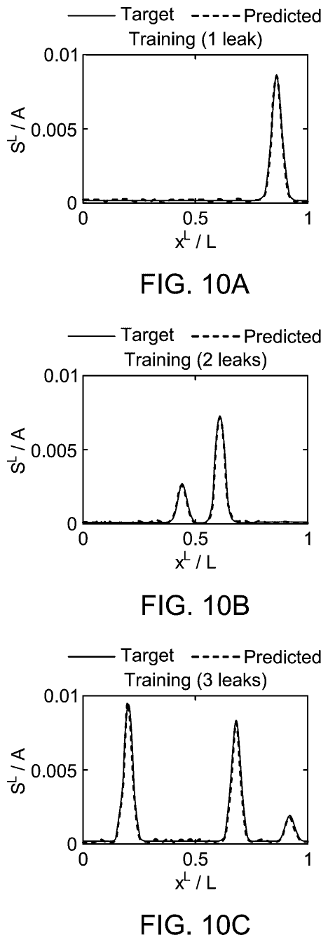

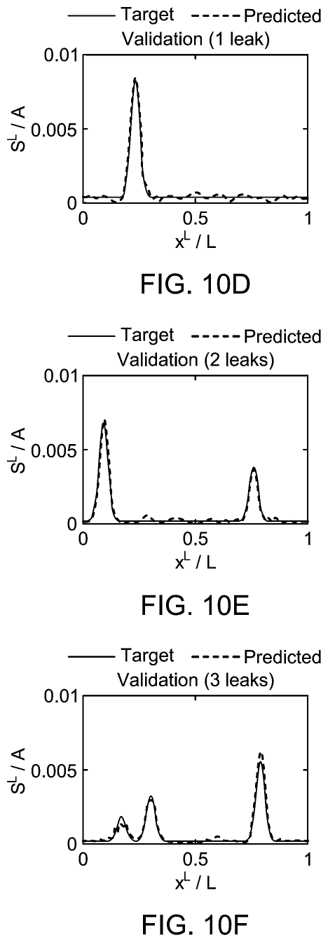

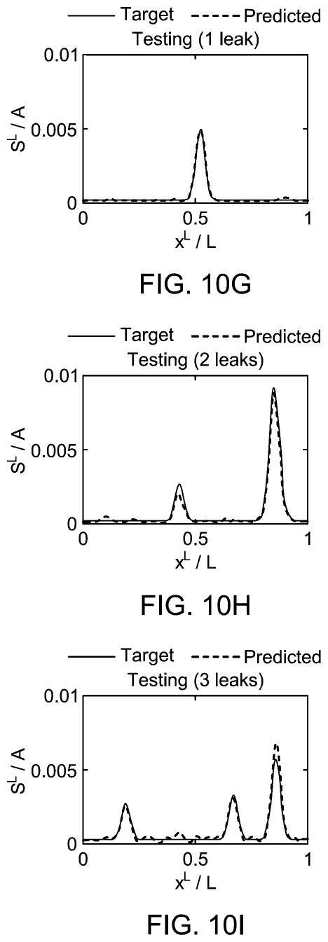

It may be noted that while regression plots provide valuable insights, they may not always offer a complete picture of the predictive performance of the neural network model 140, especially when considering the full scope of leak properties (numbers, sizes, and locations). As such, reliance on regression plots alone may not appropriately depict the capabilities of the neural network model 140. Therefore, a domain-guided approach to performance assessment is also employed, as depicted in FIGS. 10A-10I. Herein, the normalized leak size s^{L}/A is plotted against the normalized leak location x^{L}/L. The solid line indicates the true values, and the dashed line represents the ANN predictions.

FIGS. 10A-10I elucidated the ability of the neural network model 140 to predict leak properties. This is achieved by plotting the normalized leak size against the normalized leak location for each scenario. This approach takes into account the intricacies of leak size, number, and location within the normalized bounds, providing a more nuanced understanding of the effectiveness of the neural network model 140. As seen across the nine plots, the neural network model 140 exhibits consistent precision in predicting leak properties for a single leak. As the number of leaks increases, the complexity of the prediction task also rises, reflected by the slight divergence between the true and predicted values. However, even in the presence of multiple leaks, the neural network model 140 maintains a noteworthy level of accuracy, as indicated by the close alignment of the predicted values to the true leak characteristics. This comprehensive evaluation method, which combines regression analysis, offers a robust framework for validating the performance of the neural network model 140 in detecting and quantifying leaks in the pipeline system 10.

Conducting repeatable transient experiments in hydraulic systems poses unique challenges, particularly when relying on manual valve operations. Such manual interventions often results in variability in valve closure times, diverging from the conditions under which the neural network model 140 is usually trained. This variability is an important aspect, as it significantly influences the characteristics of the transient waves such as the bandwidth, waveform, and wavelength. To address this, the pre-trained model, designated as BaseModel, is adapted using refinement techniques. The initial phase of adaptation involves retraining BaseModel on a dataset that reflects a range of valve closure times (T_{c}∈[0.02, 0.08] seconds), capturing the realistic operational variations. The refined model is referred to as AdaptedModel-1. The training performance curves (i.e., loss function, gradient of the loss function and validation fails) are provided. The performance metrics are summarized in Table 2 (below).

TABLE 2
Performance metrics of various models during training, validation and testing stages

| Model | Stage | R-squared | RMSE | MSE | MAE | PCC |
|---|---|---|---|---|---|---|
| BaseModel | Training | 0.99672 | 0.008486 | 7.2 × 10⁻⁵ | 0.00496 | 0.99836 |
| | Validation | 0.96216 | 0.028785 | 0.00082855 | 0.013993 | 0.98093 |
| | Testing | 0.96133 | 0.029342 | 0.00086095 | 0.014503 | 0.98075 |
| AdaptedModel-1 | Training | 0.99514 | 0.015099 | 0.00022797 | 0.0087127 | 0.99757 |
| | Validation | 0.97558 | 0.034736 | 0.0012066 | 0.015862 | 0.98773 |
| | Testing | 0.97634 | 0.032789 | 0.0010747 | 0.01525 | 0.9881 |
| AdaptedModel-2 | Training | 0.99451 | 0.015836 | 0.00025078 | 0.0091151 | 0.99725 |
| | Validation | 0.97806 | 0.031309 | 0.00098026 | 0.014559 | 0.98901 |
| | Testing | 0.97767 | 0.032868 | 0.0010803 | 0.015245 | 0.98883 |
| AdaptedModel-3 | Training | 0.98614 | 0.022106 | 0.00048867 | 0.011841 | 0.99304 |
| | Validation | 0.96784 | 0.034039 | 0.0011587 | 0.015799 | 0.98381 |
| | Testing | 0.96231 | 0.037285 | 0.0013901 | 0.016879 | 0.98102 |

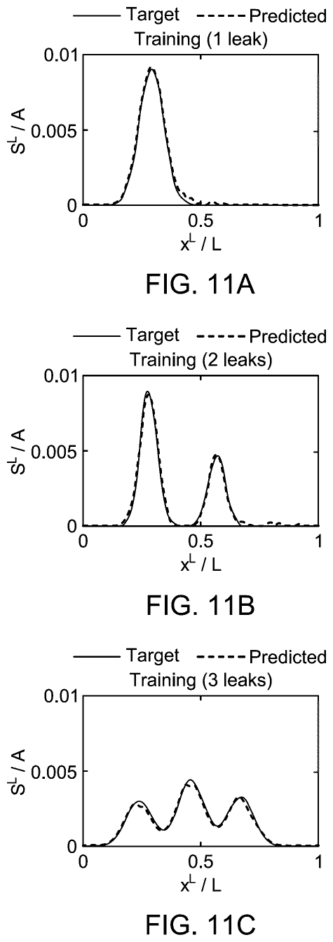

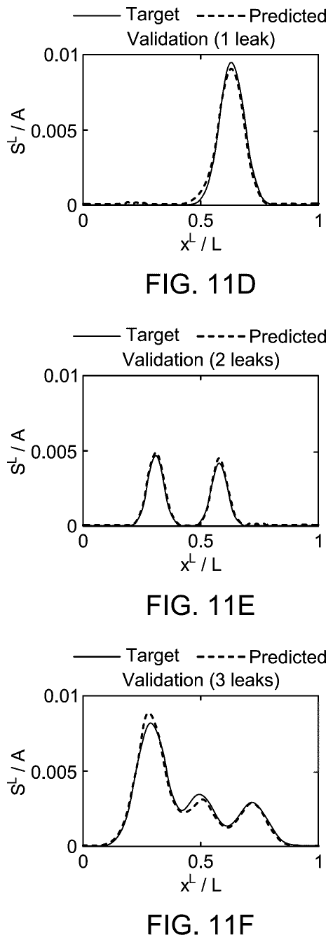

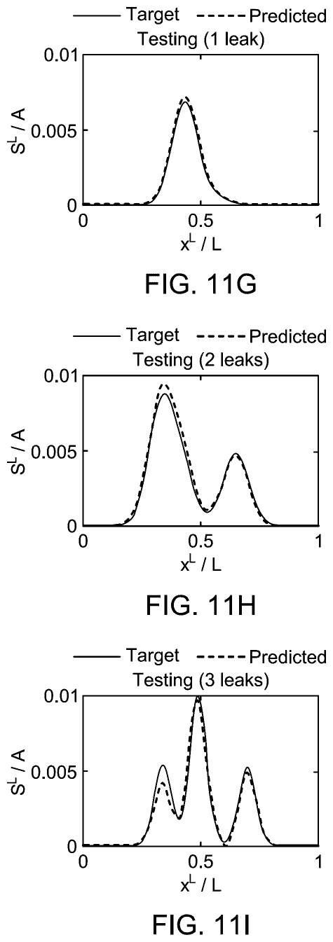

Further, the efficacy of the refined model in predicting leak functions is depicted in FIGS. 11A-11I. Herein, the normalized leak size s^{L}/A is plotted against the normalized leak location x^{L}/L. The solid line indicates the true values, and the dashed line represents the ANN predictions. The role of valve time closure (Tc) is indicative in terms of the width of the localizing lobe in each sub-plot as it is dictated by the wavelength of the injected signal. The influence of valve closure time (T_{c}) is apparent. The width of the leak signature lobe in each subplot correlates with the wavelength of the induced signal, which is integral to the leak function computation as stipulated in Equation (6).

In the subsequent refinement stage, AdaptedModel-1 undergoes additional enhancement to account for variations in the pre-transient flow rate at the valve location, symbolized as Q_{0,v}, along with the valve closure time (T_{c}∈[0.02, 0.08] seconds). The integration of Q_{0,v} is required, as it dictates the amplitude of the incident wave through Joukowsky's pressure head, defined by H_{J}=(a₀Q_{0,v})/(gA), where a₀ represented the wave speed, g was the gravitational acceleration, and A is the cross-sectional area of the pipe. Notably, the reflection coefficients from potential defects are directly proportional to Joukowsky's pressure head, making it a vital factor in accurately sizing defects. Omitting this variability could lead to significant errors in estimating defect size.

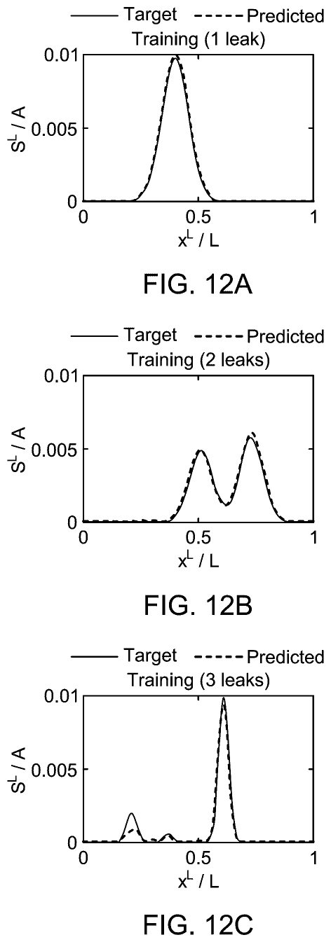

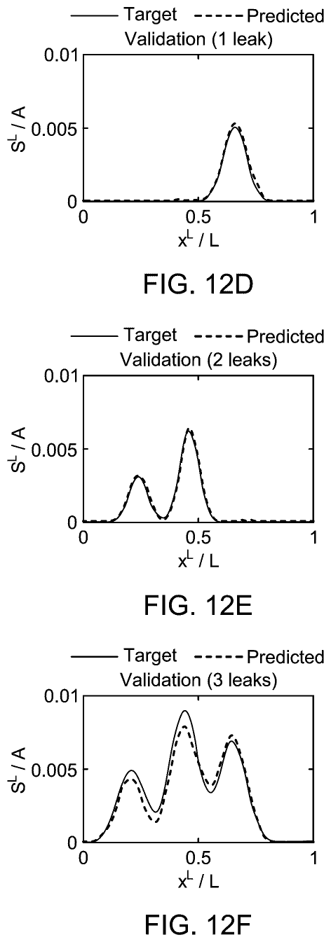

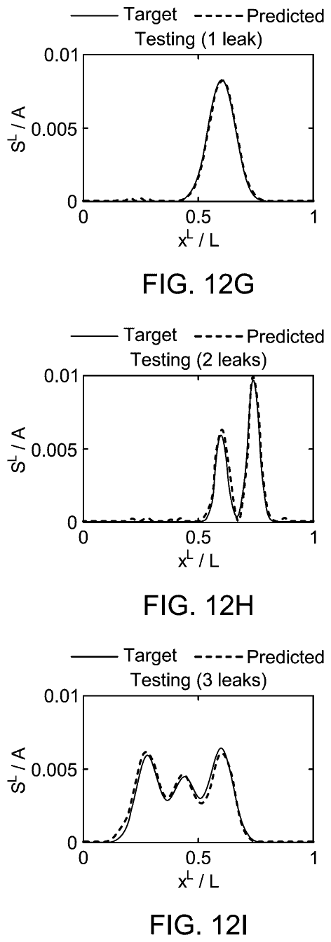

To address this, the flow rate is varied within the range of 1 to 3 liters per second, and an enriched dataset encompassing scenarios of 1, 2, and 3 leaks is constructed, with each scenario comprising 2000 samples. This dataset serves to fine-tune AdaptedModel-1, now relabeled as AdaptedModel-2. Table 2 (above) provides a detailed account of the improvements in performance metrics for AdaptedModel-2. The efficacy of this model in predicting the leak function is presented in FIGS. 12A-12I, which illustrate the performance of the neural network model 140 across the training, validation, and testing stages. Herein, the normalized leak size s^{L}/A is plotted against the normalized leak location x^{L}/L. The solid line indicates the true values, and the dashed line represents the ANN predictions. The role of valve time closure (T_{c}) is indicative in terms of the width of the localizing lobe in each sub-plot as it is dictated by the wavelength of the injected signal which is directly used in equation (6) to compute the leak function. While there are slight discrepancies in leak size prediction, the precision in leak localization is maintained with remarkable accuracy, and no extraneous side lobes are evident. This fortifies the dependability of the neural network model 140 in consistently identifying leak characteristics, including size, location, and quantity.

Subsequently, AdaptedModel-2 is advanced to tackle scenarios involving four leaks. To facilitate this, an augmented dataset comprising 2000 samples, each characterized by four leaks, is simulated, which serve as the new training ground for the neural network model 140. The updated model, designated as AdaptedModel-3, is adept at capturing the variability across three primary parameters: valve closure time, pre-transient flow rate, and the number of leaks, now extending up to four. The training performance of AdaptedModel-3, delineated by its learning curves, and the values of various performance metrics are provided in Table 2 (above).

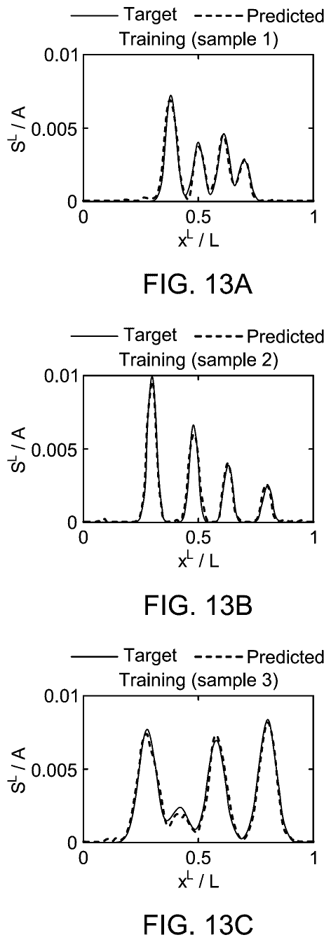

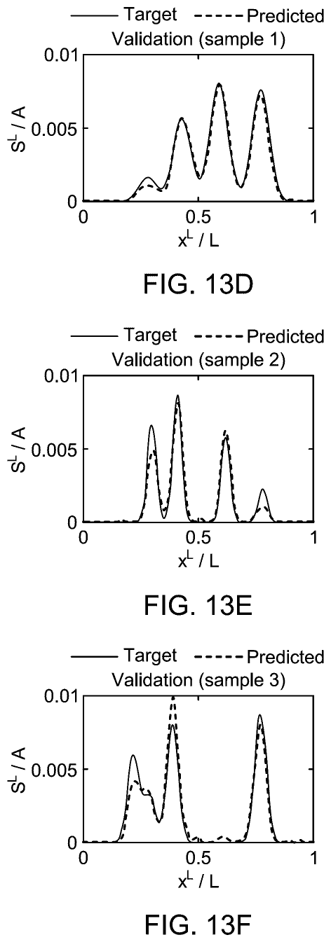

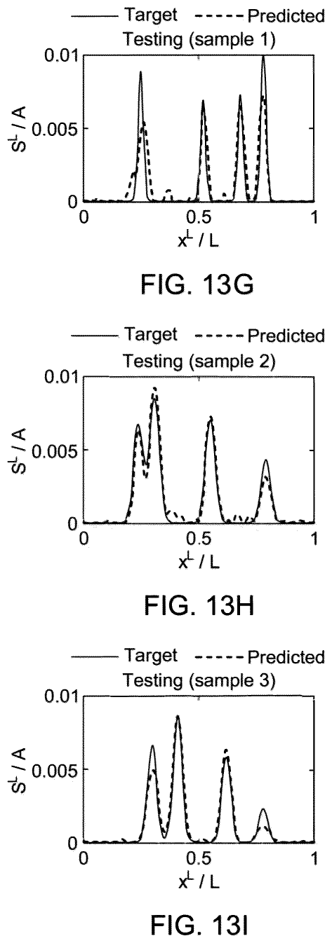

Furthermore, the predictive accuracy of the neural network model 140 concerning the leak function is demonstrated in FIGS. 13A-13I. Herein, the normalized leak size s^{L}/A is plotted against the normalized leak location x^{L}/L. The solid line indicates the true values, and the dashed line represents the ANN predictions. The role of valve time closure (T_{c}) is indicative in terms of the width of the localizing lobe in each sub-plot as it is dictated by the wavelength of the injected signal which is directly used in equation (6) to compute the leak function. FIGS. 13A-13I selectively exhibit three instances from each phase, training, validation, and testing, to visually convey the proficiency of the neural network model 140. Notably, AdaptedModel-3 consistently identified all four leaks with remarkable precision in both size and location.

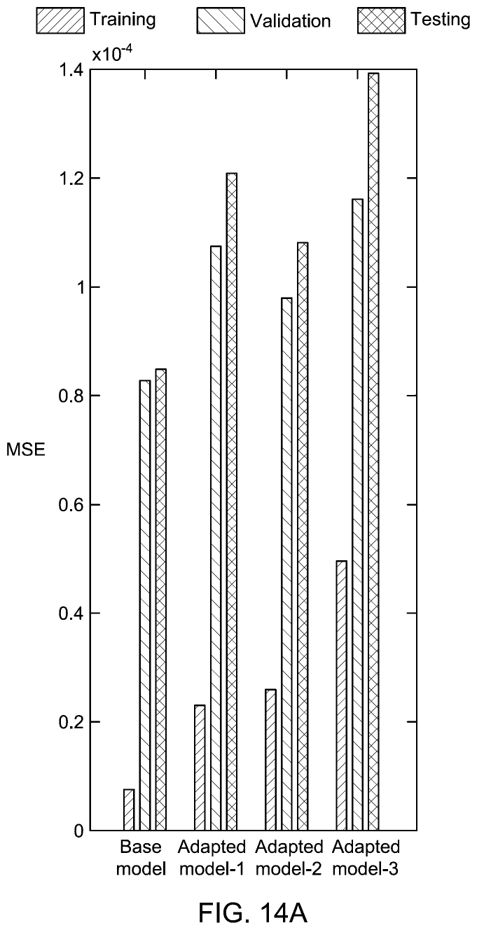

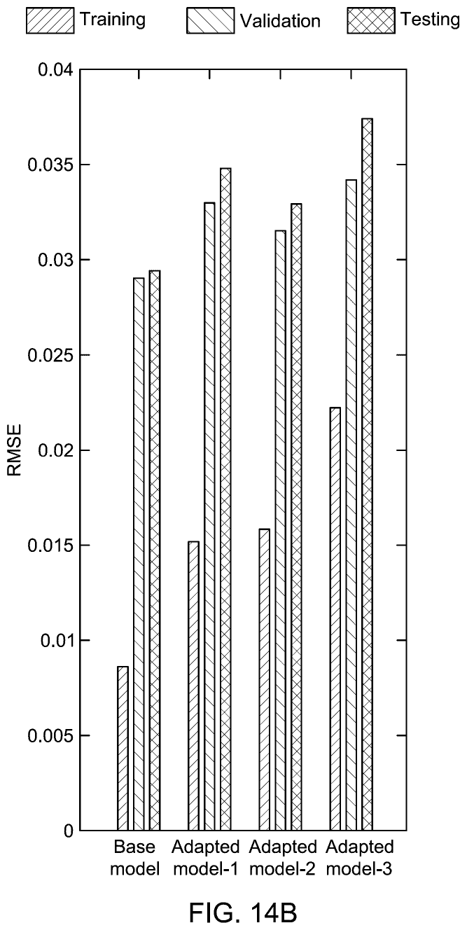

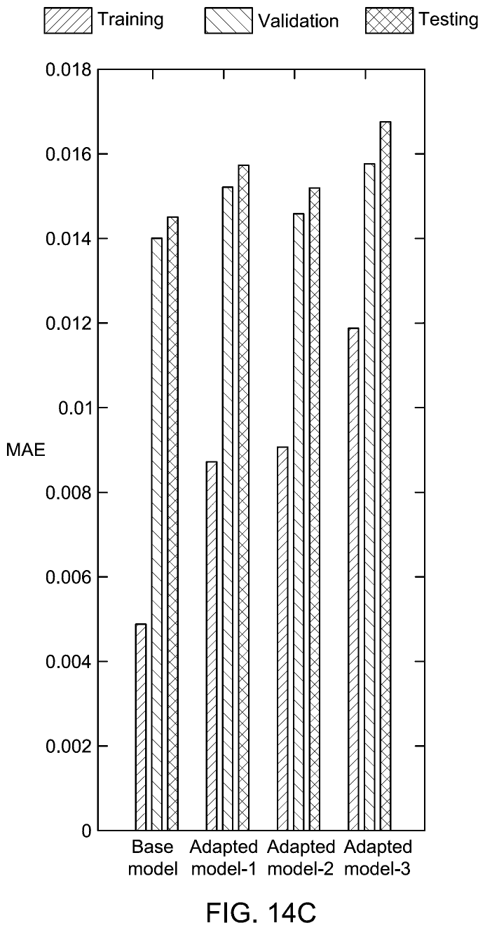

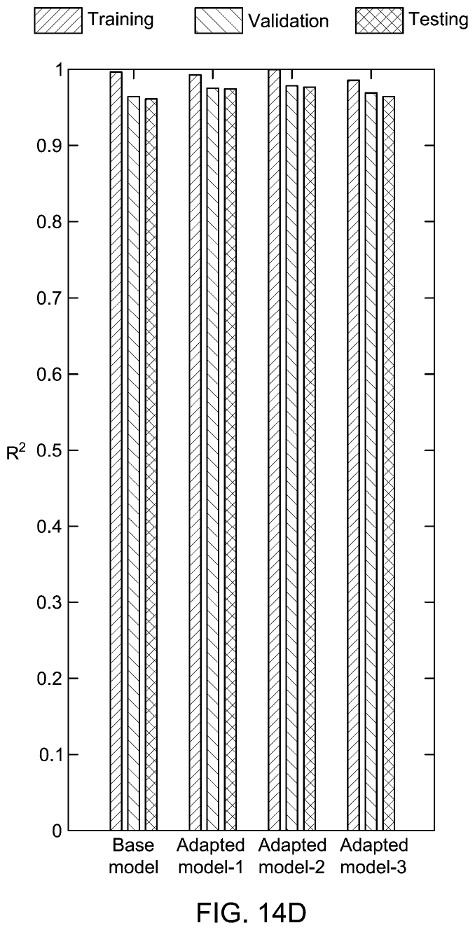

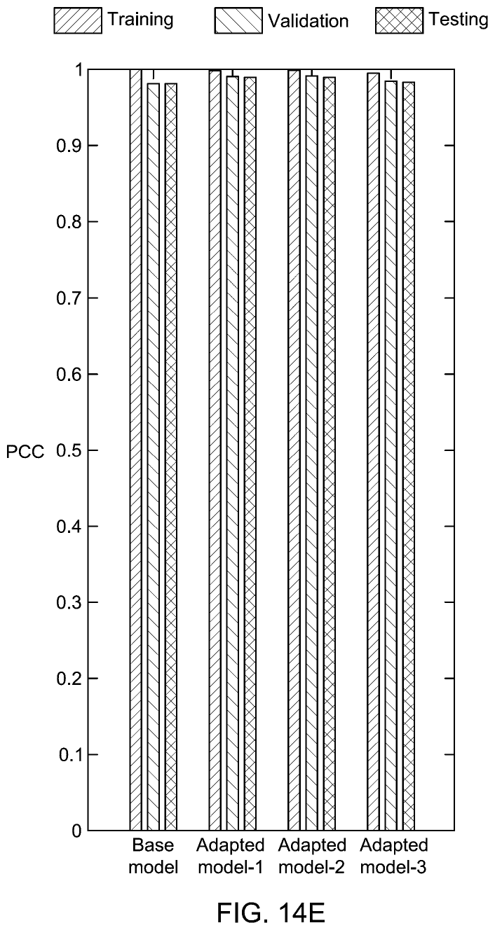

FIGS. 14A-14E visualize the performance metrics detailed in Table 2 (above), offering a graphical representation of the proficiency of the neural network model 140 throughout the training, validation, and testing stages. In particular, FIGS. 14A-14E illustrate the progression of performance metrics across different models, from the BaseModel to AdaptedModel-3. FIG. 14A through FIG. 14E respectively depict MSE, RMSE, MAE, R-squared, and PCC, showcasing performance of each model during training, validation, and testing phases. The systematic reduction in error metrics (MSE, RMSE, and MAE) and concurrent increase in R-squared and PCC from BaseModel to AdaptedModel-3 highlight the efficacy of the refinement process in enhancing model accuracy and consistency across various stages of evaluation. Specifically, the error metrics, MSE, RMSE, and MAE, exhibit an ascending trend, and the fit quality indicators, R-squared and PCC, show a descending trend as the BaseModel evolved through AdaptedModel-1 to AdaptedModel-3. This trend reflects the confrontation of the neural network model 140 with increasing variability in the input data, including uncertainties in critical parameters such as valve closure time, pre-transient flow rate, and the number of undetermined leaks. While an escalation in error through the stages of validation and testing relative to training is observed, indicating no over-fitting, it indicates the increasing challenges of the neural network model 140 in capturing the complexity of the data. This increase is a predictable consequence of exposing the neural network model 140 to broader operational dynamics and serves as an impetus for further enhancement. The incorporation of a more diverse training dataset stands as a viable approach to refine the performance of the neural network model 140, enabling it to better generalize across the spectrum of variability and uncertainty inherent in real-world applications.

The examples presented herein served to underscore the effectiveness of the disclosed framework, which adeptly accommodated variability in both physical parameters and unforeseen operational conditions. This adaptability is achieved through the addition of a relatively small training dataset, demonstrating that significant refinements can be realized in a remarkably short training duration, approximately 50 minutes for each stage of enhancement. Such illustrative advancements pave the way for improvements, including the accommodation of wave speed variations, the mitigation of ambient noise, and the handling of scenarios involving an increased number of leaks. Herein, the neural network model 140 maintains a consistent output dimensionality regardless of the number of leaks, distinguishing it from traditional approaches that require resizing the output vector to match the number of predicted leak sizes. This consistency is a testament to the potential of the methodology for practical field deployment, offering a paradigm shift in the use of machine learning for leak detection within hydraulic systems.

The leak detection system 100 is extended to handle pipeline networks by organizing the leak functions into a vector format. For a network consisting of NP pipes, where [symbol] ₙ (for n=(1, 2, . . . , NP)) denote the leak function for the n-th pipe branch, the resulting target vector is organized as:

$$\\ {ℒ}_{T} = {[ {ℒ}_{1} , {ℒ}_{2} , … , {ℒ}_{n} , … , {ℒ}_{NP} ]}^{⊤}$$

where τ denotes the vector transpose, and [symbol] _{τ} is the comprehensive target output vector. Similarly, the input pressure head from various locations is organized as follows. Supposing there are N M sensors, and

$$\\ {h}_{m}^{j} ( for j = ( 1 , 2 , … , NM ) )$$

represents the pressure head signal from the j-th sensor, the resulting input vector can be organized as

$$\\ {h}_{I} = {[ {h}_{m}^{1} , {h}_{m}^{2} , … , {h}_{m}^{j} , … , {h}_{m}^{NM} ]}^{⊤}$$

where h₁ denotes the comprehensive input vector. This approach allows the leak detection system 100 to incorporate multiple pipelines and pressure sensors, making the neural network model 140 extendable to a pipeline network.

To demonstrate the performance of the leak detection system 100, two examples of pipe networks are considered: (1) a system with two pipes connected in series, and (2) a tree-type network with three pipelines, as shown in FIGS. 15A and 15B respectively.

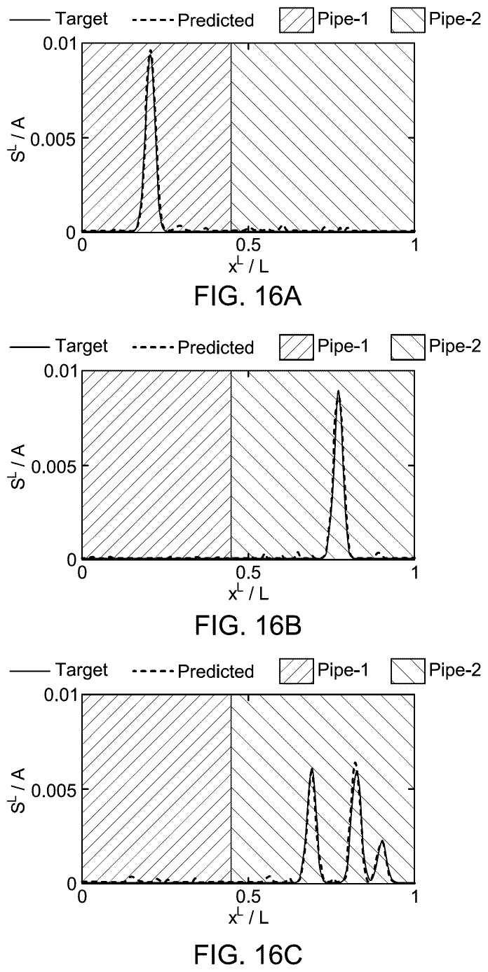

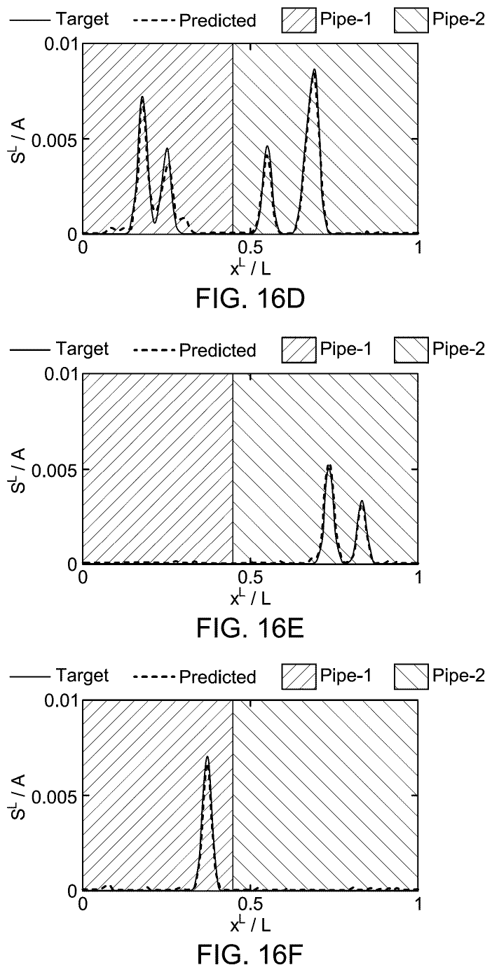

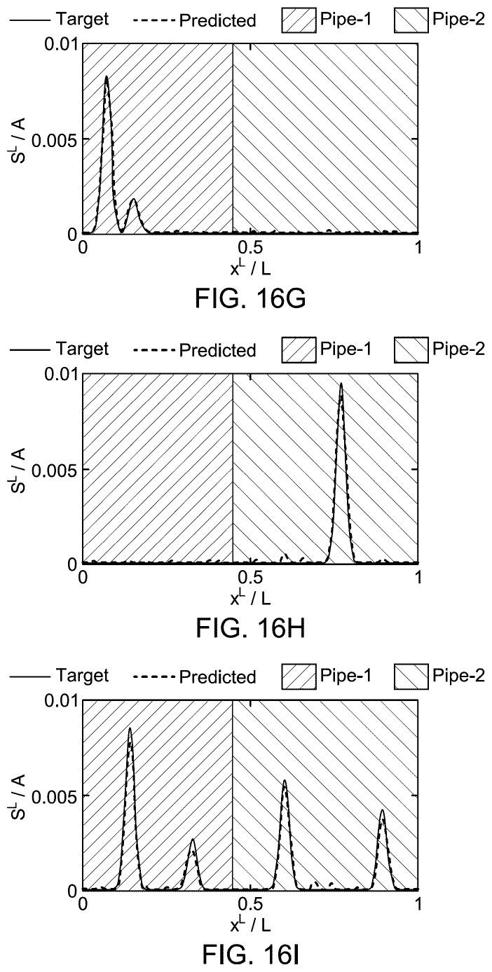

For the pipe-in-series example, two pipes are connected in series (see FIG. 15A), with lengths of 250 m and 300 m, and diameters of 150 mm and 140 mm, respectively. The wall thicknesses of these pipes are 5 mm and 4 mm. Both pipes are elastic, with a Modulus of Elasticity of 170 GPa, resulting in transient wave speeds of 1244 m/s and 1218 m/s in Pipe 1 and 2, respectively. The upstream end of the first pipe is connected to a reservoir, and the downstream end of the second pipe is fitted with a valve, constantly supplied with water at 2 LPS and a pressure of 40 m. The sampling frequency is set to 250 Hz, and the total simulation time is defined as T=3×4(L₁/a₁+L₂/a₂), where 3 denotes the total number of water hammer wave periods, and 4 characterizes the number of trips the initiated wave makes to complete one cycle. Datasets are generated under various scenarios: one leak in pipe 1, one leak in pipe 2, one leak in both pipe 1 and pipe 2, and similarly for two and three leaks. A total of 18,000 samples (2000 for each scenario) are simulated and compiled into a dataset. The pressure head signal from only one location is utilized, although a higher number of sensor locations could be employed for more complex systems. The neural network model 140 architecture is optimized through a trial and error approach, consisting of layers with [400, 400, 300, 200] neurons. Given the substantial size of the training dataset, the dataset is divided into five subsets, each comprising 3,600 samples from various scenarios. The model is initially trained on subset 1, followed by sequential retraining on the subsequent data subsets. A 70:20:10 ratio for training, validation, and testing is maintained throughout. The final training stage requires approximately 3 hours, culminating in a total training time of around 8 hours. FIGS. 16A-16I present the comparative results for the pipe-in-series system of FIG. 15A, for each of three different phases, i.e., training, validation, and testing, and with each one of three randomly selected examples that illustrated the performance of the neural network model 140. The predictions of the neural network model 140 closely aligned with the true values.

For the tree-type pipe network example, the leak detection system 100 is tested on a more complex configuration. A tree-type pipe network is considered as shown in FIG. 15B. The lengths of the pipes are L₁=250 m, L₂=300 m, and L₃=250 m, with diameters of 150 mm, 140 mm, and 160 mm, respectively. The wall thicknesses are 5 mm for pipe 1, 4 mm for pipe 2, and 6 mm for pipe 3. All pipes have a modulus of elasticity of 170 GPa, resulting in wave speeds of 1244 m/s for pipe 1, 1218 m/s for pipe 2, and 1234 m/s for pipe 3. The valve at the downstream end of pipe 3 is maintaining a steady-state flow rate of 2 LPS at a pressure head of 40 m. This valve is used for transient generation. The sampling frequency is set at 250 Hz. The total simulation time is defined as T=3×4(L₁/a₁+L₂/a₂), considering L₂>L₃. Various scenarios are simulated, including a single leak in each of pipes 1, 2, and 3, as well as combinations of leaks across the three pipes, and for two and three leaks simultaneously. In total, 24,000 samples (2,000 per scenario) are simulated and compiled into a dataset. The measurement station is located at the downstream end of pipe 3.

An optimized neural network model 140 with a structure of [400, 400, 300, 300, 300] is employed. All other hyperparameters are consistent with those described in Table 1 (above). The dataset is pre-processed as outlined above. For training, the dataset is divided into four subsets. The model, initially trained on subset 1, underwent fine-tuning with subset 2, 3, and 4. Following that, the refined model undergoes a final training phase over the entire dataset. The training, validation, and testing split is kept at a 70:20:10 ratio. The entire model development process takes approximately 9.5 hours.

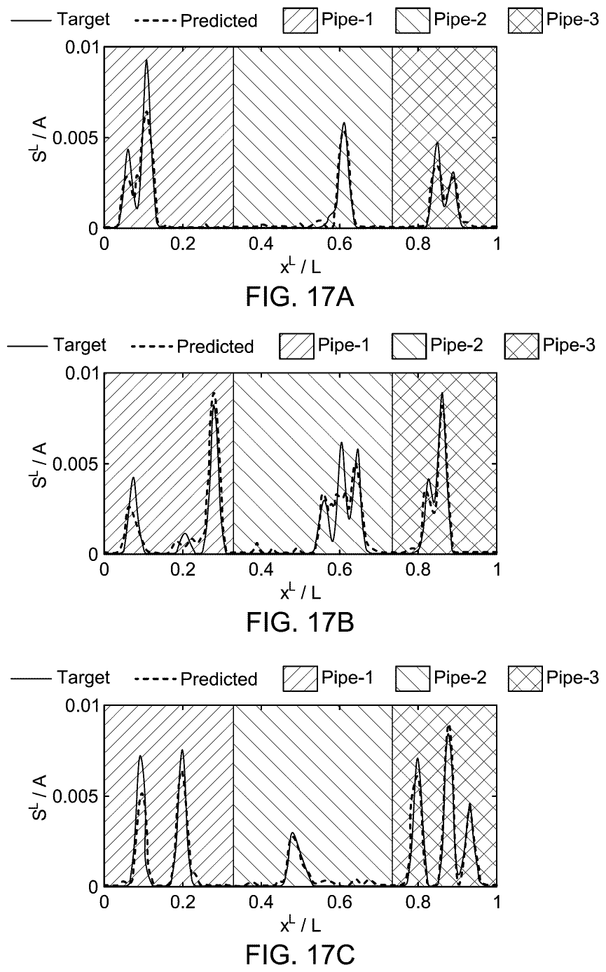

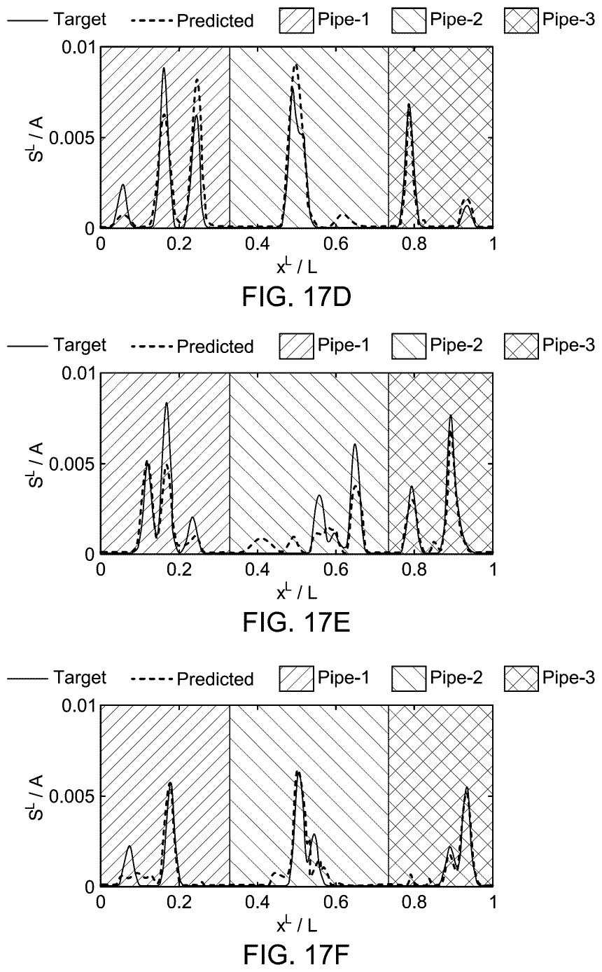

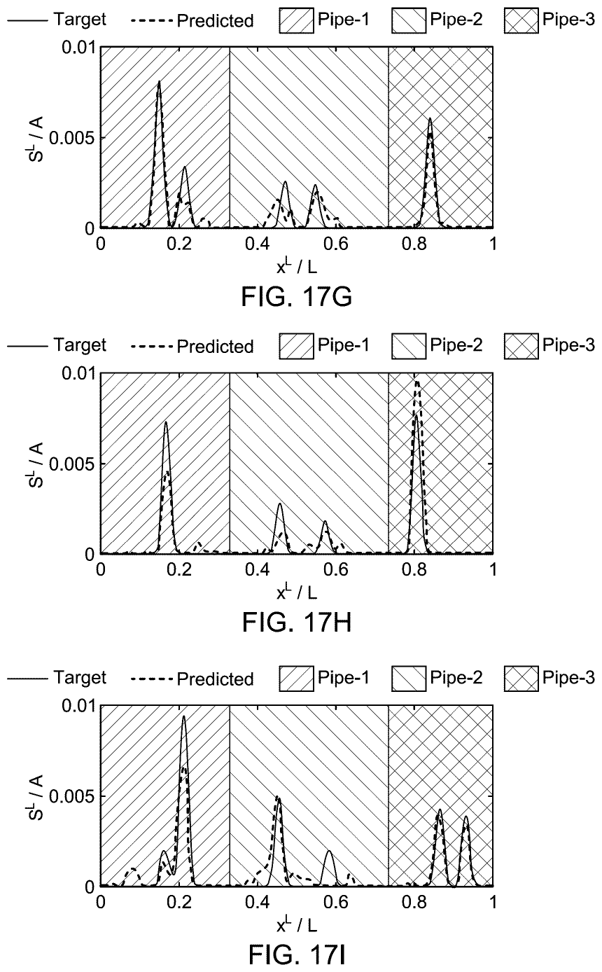

FIGS. 17A-17I provide a comparative assessment of the actual versus predicted leak properties by the neural network model 140 for a tree-type pipe system, for each distinct dataset phase, i.e., training, validation, and testing. Each phase utilizes three randomly selected examples, illustrating the accuracy of the neural network model 140. It is evident that the neural network model 140 maintains high precision in leak localization across all dataset phases. However, there are noticeable discrepancies in leak size estimation, especially for adjacent leaks. Spurious minor lobes are also detected with minimal height in the training phase, and moderate height in validation and testing, possibly indicating the need for a denser model with more number of layers/neurons. These findings indicate that the disclosed neural network model 140 is capable and adaptable to complex pipeline systems. The presence of closely spaced peaks indicated that the neural network model 140 is sufficiently sensitive to distinguish between proximate leak events, which is essential in dense pipeline networks. Nevertheless, as the complexity of the system increases, the neural network model 140 can be configured with a higher capacity, potentially more layers and neurons, to effectively model the intricate relationships within the data without compromising the accuracy.

The leak detection system 100 introduces a machine learning-based framework for localizing and sizing multiple leaks in pressurized pipelines. A comprehensive numerical dataset, generated using a time-domain hydraulic transient model with the method of characteristics, can be utilized to train the neural network model 140. This neural network model 140 features a five-layer architecture with 400, 400, 300, 300, and 200 neurons, and processed pressure head signals corrupted with Gaussian noise for leak detection.

Systematic evaluation of numerical examples demonstrates the ability of the neural network model 140 to accurately predict single and multiple leaks (up to four), amidst modeling uncertainties such as valve closure time, pre-transient pressure head, and flow rate variations. The dataset, consisting of 2000 samples per scenario, is divided into training, validation, and testing subsets in a 70-20-10 split, ensuring the robustness and reliability of the neural network model 140. The initial training of the baseline model can be completed in approximately 2.5 hours, with each subsequent refinement requiring an additional hour, indicating the efficiency of the method.

The leak detection system 100 can also be extended to handle complex pipeline configurations, including systems with two pipes connected in series and tree-type networks with three pipes. This extension involves generating datasets using the hydraulic transient model, optimizing the architecture of the neural network model 140, and strategically training the neural network model 140 with small datasets instead of using the entire dataset at once. The leak detection system 100 shows adaptability to complex systems with moderately accurate results. Furthermore, as system complexity increases, the predictions of the neural network model 140 may deviate from the anticipated output. This issue may be addressed by increasing the number of layers and neurons in the neural network model 140. Also, this approach can include careful tuning of the architecture and selection of optimal hyperparameters for the neural network model 140.

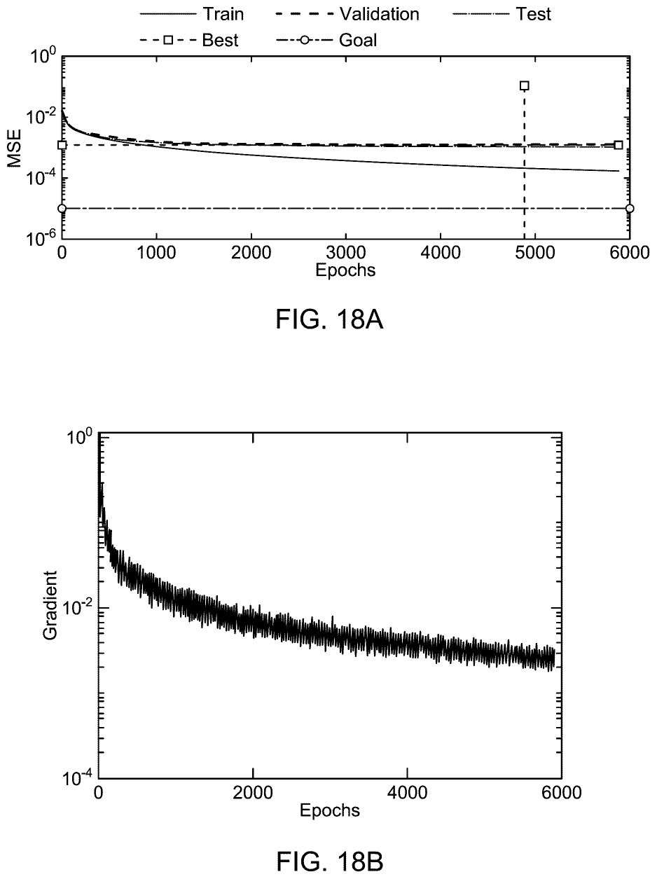

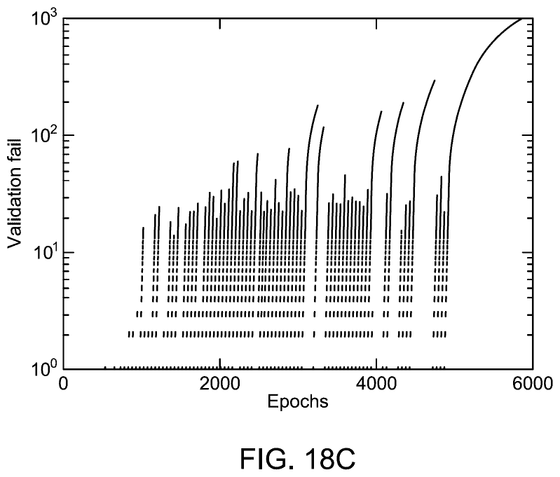

FIGS. 18A-18C present the improved predictive performance of AdaptedModel-1. Notably, the mean squared error (MSE) illustrated in FIG. 18A did not originate from a high value, indicating that the pre-tuned model parameters only require recalibration. This process was efficiently completed in approximately 5800 epochs and 49 minutes, meeting the predefined threshold of 1000 validation failures.

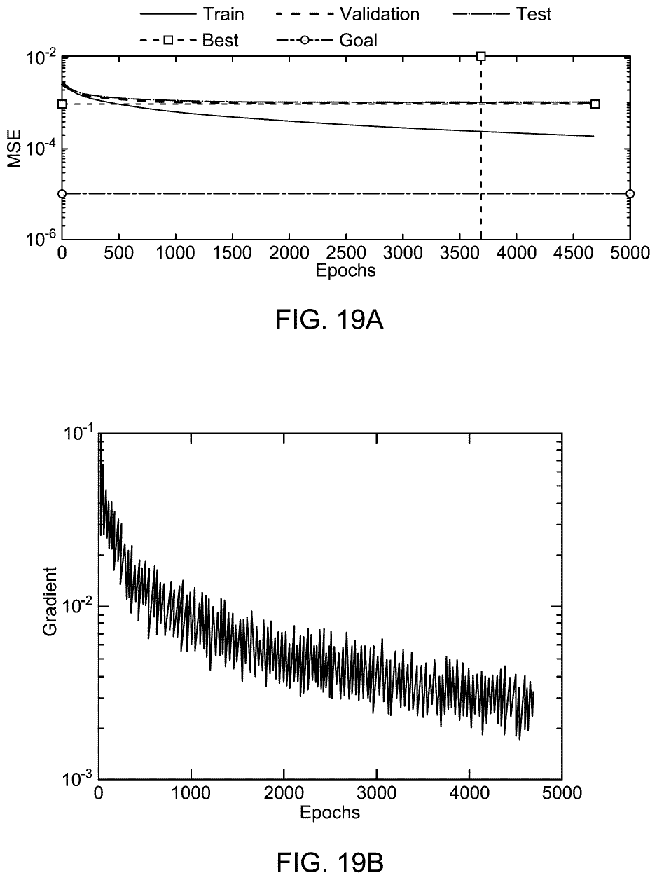

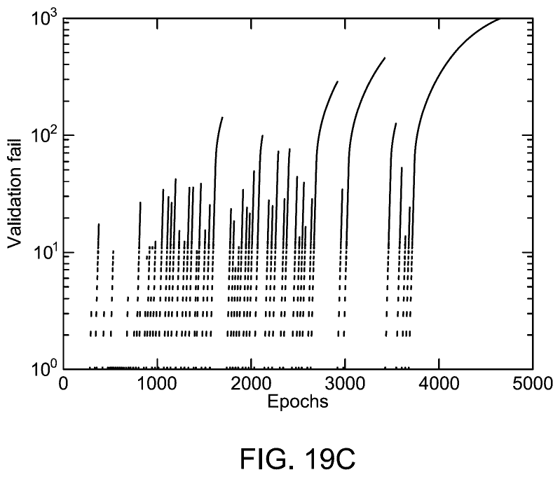

The training performance curves of AdaptedModel-2, comprising the loss function, the loss function gradient, and the validation failures, are graphically summarized in FIGS. 19A-19C. This iteration of the model exhibited fine-tuned synaptic parameters, adapting to the combined variability of valve closure and the corresponding Joukowsky pressure head in the transient data. This comprehensive tuning was accomplished in just 43 minutes over 5000 epochs.

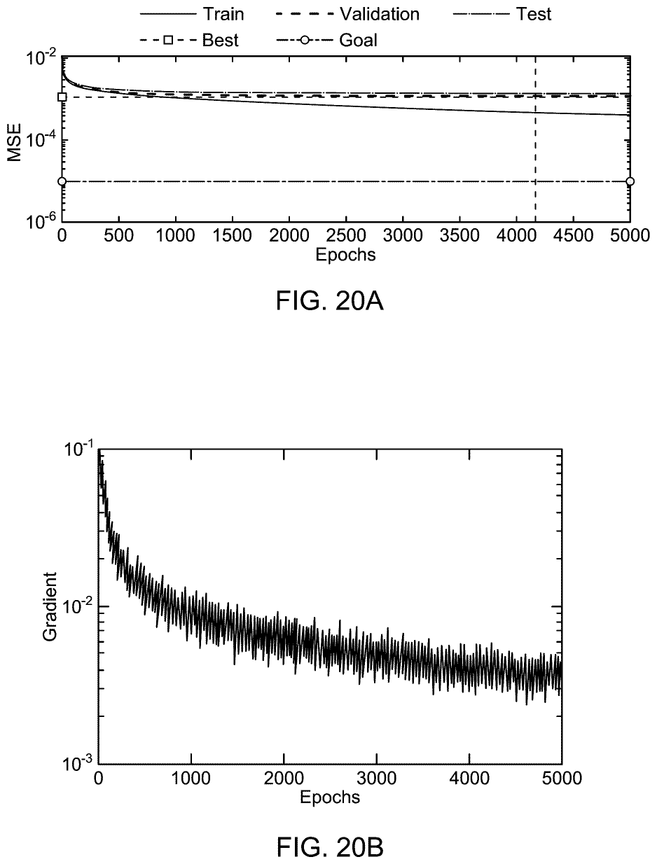

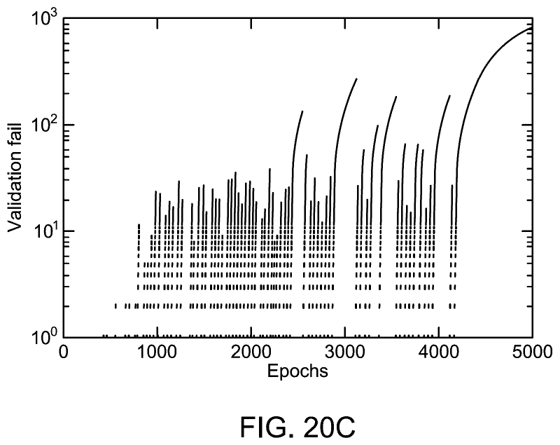

The training performance of AdaptedModel-3 is depicted through metrics including the loss function, its gradient, and validation failures, as illustrated in FIGS. 20A-20C. This version of the neural network model 140 can be calibrated to accommodate the combined variability of valve closure time and pre-transient flowrate, as well as scenarios involving four leaks. This extensive fine-tuning can be achieved within a span of approximately 52 minutes across 5000 epochs, demonstrating the efficiency of the neural network model 140 in adapting to complex hydraulic conditions.

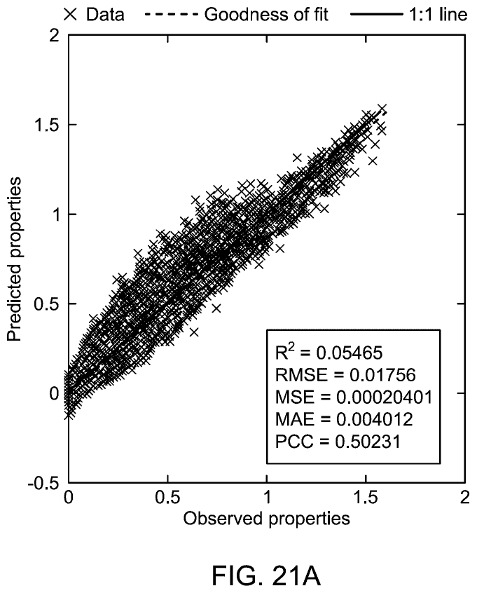

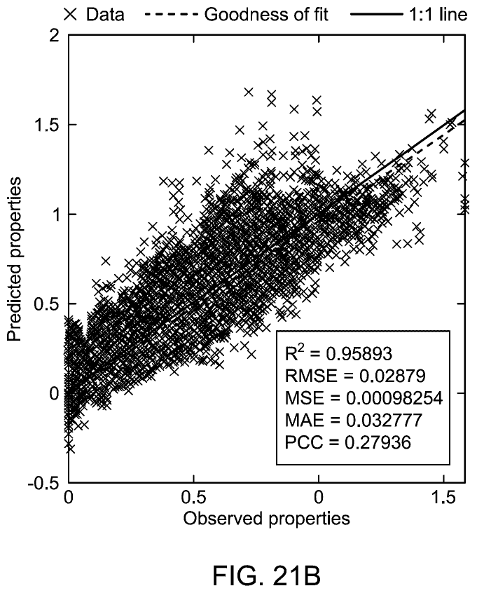

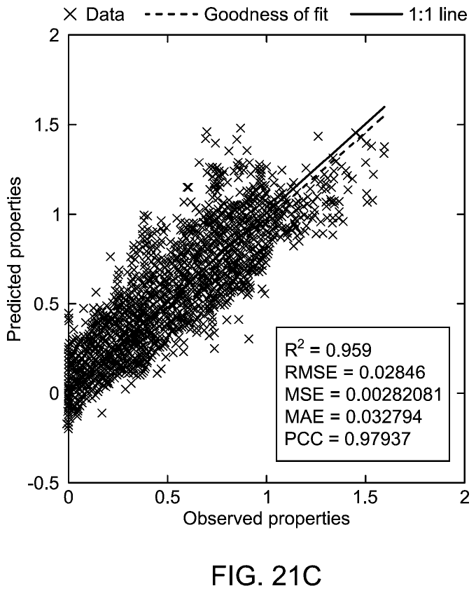

For the pipe-in-series system, FIGS. 21A-21C present the regression analysis of the neural network model 140 across different datasets: (a) training, (b) validation, and (c) testing. Each figure plots the predicted properties against the observed properties, with the data points marked as crosses. The dashed line represents the goodness of fit of the neural network model 140, while the solid line indicates the ideal 1:1 correspondence between the predicted and observed values. Performance metrics such as R², RMSE, MSE, MAE, and PCC are displayed for each dataset, demonstrating the accuracy and predictive capability of the neural network model 140 for the pipe-in-series configuration.

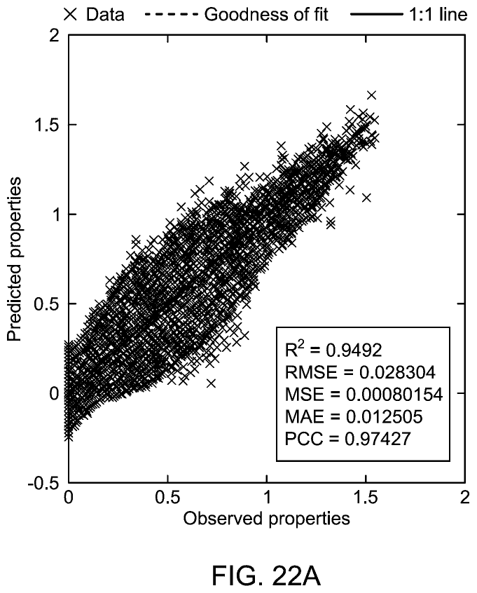

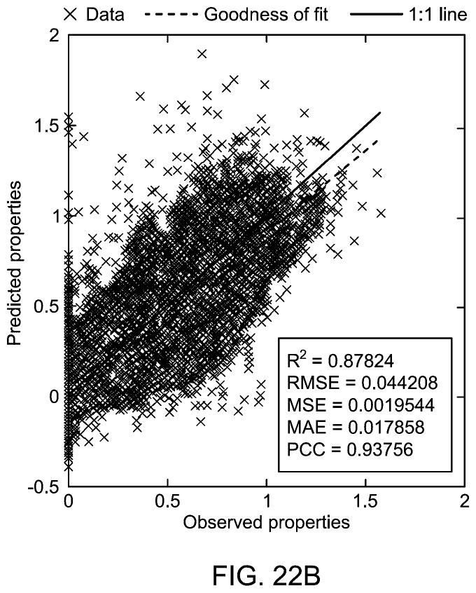

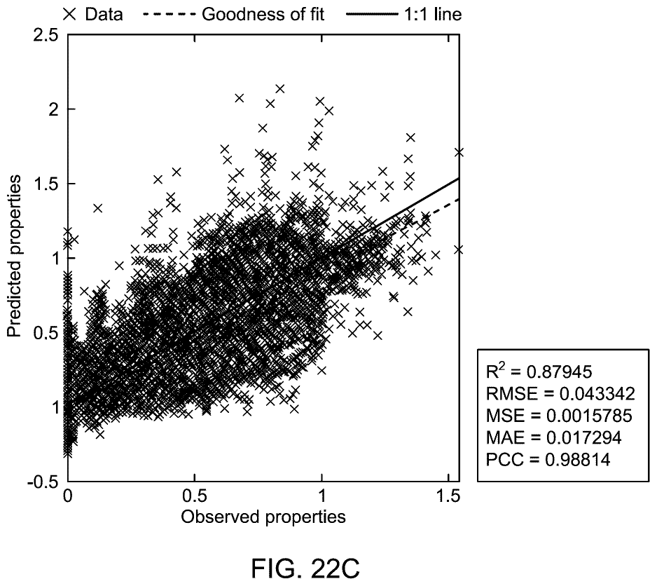

For the tree-type pipe network, FIGS. 22A-22C present the regression analysis of the neural network model 140 across different datasets: (a) training, (b) validation, and (c) testing. Each figure plots the predicted properties against the observed properties, with the data points marked in crosses. The dashed line represents the goodness of fit of the neural network model 140, while the solid line indicates the ideal 1:1 correspondence between the predicted and observed values. Performance metrics such as R², RMSE, MSE, MAE, and PCC are displayed for each dataset, demonstrating the accuracy and predictive capability of the neural network model 140 for the more complex tree-type network configuration.

These regression analyses provide a comprehensive view of the performance of the neural network model 140 across different pipeline configurations and dataset phases. The displayed metrics allow for a quantitative assessment of accuracy and reliability of the leak detection system 100 in various scenarios, from simpler pipe-in-series systems to more complex tree-type networks.

The results demonstrate that the leak detection system 100 maintained good predictive performance across different pipeline configurations, although the accuracy tends to decrease slightly with increasing system complexity. This observation aligns with the earlier noted challenges and improvements in the neural network model 140, can include increasing model capacity or exploring alternative machine learning approaches for more complex pipeline systems.

The leak detection system 100 and the method 400 of the present disclosure, for detecting multiple simultaneous leaks within a pipeline system that transports a fluid, represents a significant advancement in the field of pipeline monitoring and maintenance. The proposed approach utilizes the neural network model 140 that maps transient pressure head signals to an output leak function, which is a probability density function proportional to the length of the pipeline system, such that the dimension of the output leak function is a fixed dimension of an output layer of the neural network model 140, independent of the number of leaks present. This allows the leak detection system 100 to detect and localize multiple leaks simultaneously without requiring changes to the network architecture, providing a flexible and scalable solution for various leak scenarios.

Unlike conventional leak detection techniques that often struggle with multiple leak scenarios or require separate models for different numbers of leaks, the leak detection system 100 can handle varying numbers of leaks with a single model. The ability of the leak detection system 100 to accommodate for variability in valve closure time, pre-transient flow rates, and pressure heads enhances its applicability in real-world scenarios. Further, the leak detection system 100 is adaptable to complex pipeline configurations, including tree-type networks with three or more connected pipes, making it suitable for a wide range of pipeline infrastructure. Furthermore, the non-intrusive nature of the leak detection system 100, utilizing only the valve 110 and the detachable pressure measurement device 120, minimizes disruption to pipeline operations during leak detection processes. The leak detection system 100 also provides a user-friendly visual output through the display 150, which shows the output leak function in conjunction with a drawing of the pipeline system 10. This visual representation, where each potential leak point is represented by a density-like lobe centered at the respective leak location, allows for intuitive interpretation of leak locations and sizes.

A first embodiment describes a leak detection system 100 for detecting multiple simultaneous leaks within a pipeline system 10 that transports a fluid, comprising: a valve 110 located at an output port 12 of the pipeline system 10 for perturbing a pressure head in the fluid in response to a valve closure by the valve 110; a detachable pressure measurement device 120 for measuring a pressure head at the output port 12; a signal acquisition unit 130 for acquiring a transient pressure head signal from the pressure measurement device 120, wherein the transient pressure head signal includes a random noise; a neural network model 140 that maps the transient pressure head signal to an output leak function, wherein the output leak function is a probability density function that is proportional to a length of the pipeline system 10, wherein a dimension of the output leak function is a fixed dimension of an output layer of the neural network model 140 that is independent of a number of leaks; and a display 150 for displaying the output leak function from the neural network model 140 in conjunction with a drawing of the pipeline system 10 with indications for locations of the multiple leaks.

In an aspect, the display 150 is configured to display the output leak function in which each potential leak point is represented by a density-like lobe, centered at a respective leak location.

In an aspect, the display 150 is configured to display the output leak function in which a peak amplitude of the lobe indicates a leak size.

In an aspect, the neural network model 140 outputs the output leak function in which a standard deviation of the lobe is proportional to wavelength of the acquired transient pressure head signal.

In an aspect, the pipeline system 10 is a tree-type network having three or more connected pipes.

In an aspect, the display 150 is configured to display the output leak function as a plot in which a horizontal axis is normalized against pipe length, and a vertical axis is normalized in relation to the pipeline system's 10 cross-sectional area.

In an aspect, the valve 110 is a shut-off valve, and wherein the neural network model 140 is calibrated to accommodate for variability of closure time of the shut-off value.

In an aspect, the valve 110 is a shut-off valve, and wherein the neural network model 140 is calibrated to accommodate for variations in pre-transient flow rate at the valve 110 location.

In an aspect, the valve 110 is a shut-off valve, and wherein the neural network model 140 is calibrated to accommodate for a combined variability of valve closure time and a pre-transient flowrate.

In an aspect, the valve 110 is a shut-off valve, and wherein the neural network model 140 is calibrated to accommodate for pre-transient pressure head in the pipeline system 10.

In an aspect, the detachable pressure measurement device 120 includes a pressure monitoring device 122, the system further comprising a connection adapter 124 in which one end is detachably connected to the output port 12 of the pipeline system 10 and another end includes a device port for connecting the pressure monitoring device 122.

In an aspect, the connection adapter 124 is one of several interchangeable connection adapters 124 of different inner diameters for connection to different types of output ports 12 of various diameters.

A second embodiment describes a method for detecting multiple simultaneous leaks within a pipeline system 10 that transports a fluid, comprising: perturbing a pressure head in the fluid, by a valve 110 located at an output port 12 of the pipeline system 10, in response to a valve closure by the valve 110; measuring, using a detachable pressure measurement device 120, a pressure head at the output port 12; acquiring, by a signal acquisition unit 130, a transient pressure head signal at the output port 12, wherein the transient pressure head signal includes a random noise; generating an output leak function by a neural network model 140, based on the transient pressure head signal, wherein the output leak function is a probability density function that is proportional to a length of the pipeline system 10, wherein a dimension of the output leak function is a fixed dimension of an output layer of the neural network model 140 that is independent of a number of leaks; and displaying, by a display 150, the output leak function from the neural network model 140 in conjunction with a drawing of the pipeline system 10 with indications for locations of the multiple leaks.

In an aspect, the displaying includes displaying the output leak function in which each potential leak point is represented by a density-like lobe, centered at a respective leak location.

In an aspect, the displaying includes displaying the output leak function in which a peak amplitude of the lobe indicates a leak size.

In an aspect, the generating, by the neural network model 140, includes generating the output leak function in which a standard deviation of the lobe is proportional to wavelength of the acquired transient pressure head signal.

In an aspect, the displaying displays the output leak function as a plot in which a horizontal axis is normalized against pipe length, and a vertical axis is normalized in relation to the pipeline system's 10 cross-sectional area.

In an aspect, the output port 12 is configured with a shut-off valve 110, the method further comprising calibrating the neural network model 140 to accommodate for variability of valve closure time.

In an aspect, the output port 12 is configured with a shut-off valve 110, the method further comprising calibrating the neural network model 140 to accommodate for variations in a pre-transient flow rate at the valve 110 location.

In an aspect, the output port 12 is configured with a shut-off valve 110, the method further comprising calibrating the neural network model 140 to accommodate for a combined variability of valve closure time and a pre-transient flowrate.

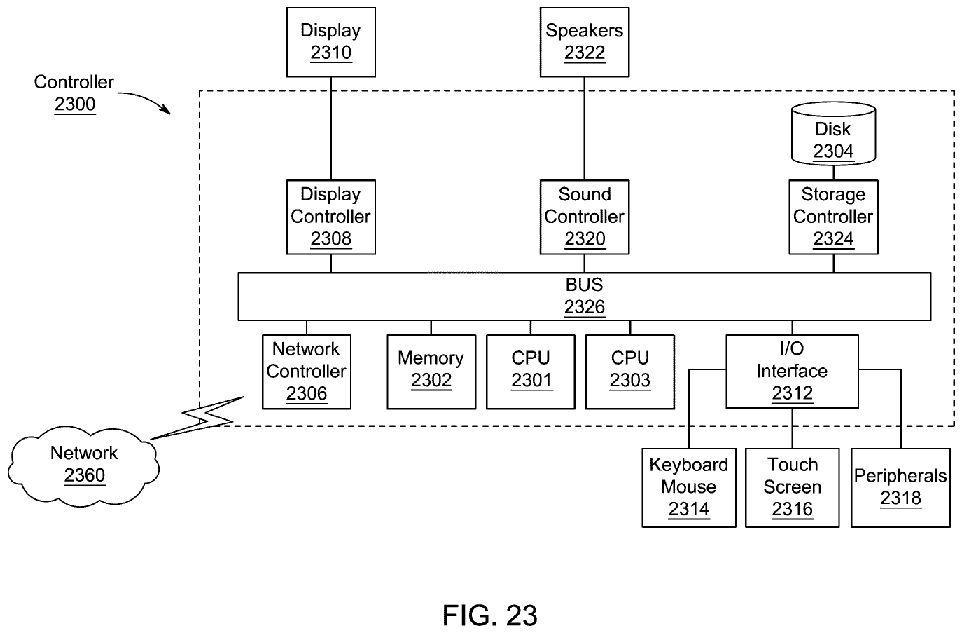

Next, further details of the hardware description of a computing environment according to exemplary embodiments is described with reference to FIG. 23. In FIG. 23, a controller 2300 is described is representative of a computing unit of the leak detection system 100, in which the controller 2300 is a computing device which includes a CPU 2301 which performs the processes described above/below. The process data and instructions may be stored in memory 2302. These processes and instructions may also be stored on a storage medium disk 2304 such as a hard drive (HDD) or portable storage medium or may be stored remotely.

Further, the present disclosure is not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the present disclosure may be provided as a utility application, background daemon, or component of an operating system, or combination thereof, executing in conjunction with CPU 2301, 2303 and an operating system such as Microsoft Windows 7, Microsoft Windows 8, Microsoft Windows 10, UNIX, Solaris, LINUX, Apple MAC-OS and other systems known to those skilled in the art.

The hardware elements in order to achieve the computing device may be realized by various circuitry elements, known to those skilled in the art. For example, CPU 2301 or CPU 2303 may be a Xenon or Core processor from Intel of America or an Opteron processor from AMD of America, or may be other processor types that would be recognized by one of ordinary skill in the art. Alternatively, the CPU 2301, 2303 may be implemented on an FPGA, ASIC, PLD or using discrete logic circuits, as one of ordinary skill in the art would recognize. Further, CPU 2301, 2303 may be implemented as multiple processors cooperatively working in parallel to perform the instructions of the inventive processes described above.

The computing device in FIG. 23 also includes a network controller 2306, such as an Intel Ethernet PRO network interface card from Intel Corporation of America, for interfacing with network 2360. As can be appreciated, the network 2360 can be a public network, such as the Internet, or a private network such as an LAN or WAN network, or any combination thereof and can also include PSTN or ISDN sub-networks. The network 2360 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The computing device further includes a display controller 2308, such as a NVIDIA GeForce GTX or Quadro graphics adaptor from NVIDIA Corporation of America for interfacing with display 2310, such as a Hewlett Packard HPL2445w LCD monitor. A general purpose I/O interface 2312 interfaces with a keyboard and/or mouse 2314 as well as a touch screen panel 2316 on or separate from display 2310. General purpose I/O interface also connects to a variety of peripherals 2318 including printers and scanners, such as an OfficeJet or DeskJet from Hewlett Packard.

A sound controller 2320 is also provided in the computing device such as Sound Blaster X-Fi Titanium from Creative, to interface with speakers/microphone 2322 thereby providing sounds and/or music.

The general purpose storage controller 2324 connects the storage medium disk 2304 with communication bus 2326, which may be an ISA, EISA, VESA, PCI, or similar, for interconnecting all of the components of the computing device. A description of the general features and functionality of the display 2310, keyboard and/or mouse 2314, as well as the display controller 2308, storage controller 2324, network controller 2306, sound controller 2320, and general purpose I/O interface 2312 is omitted herein for brevity as these features are known.

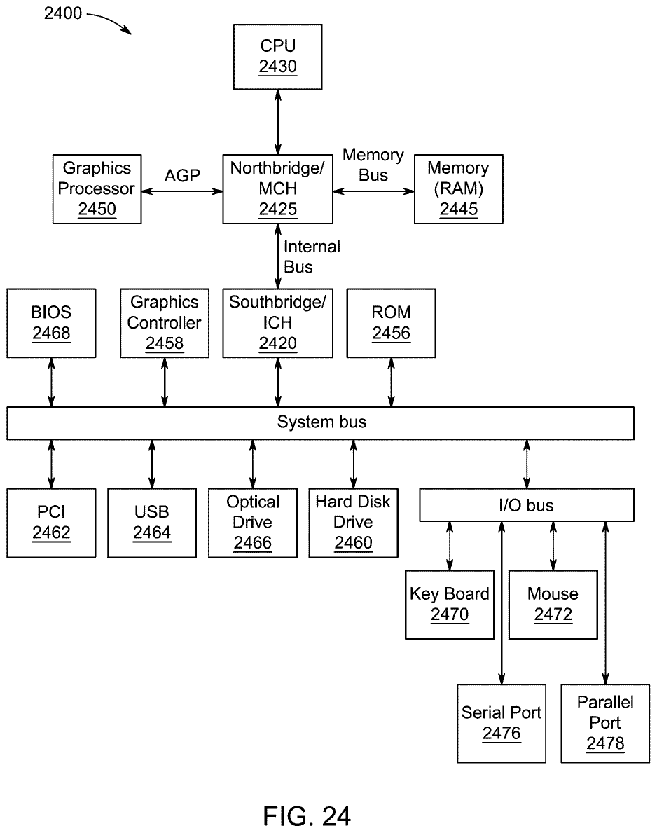

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 24.

FIG. 24 shows a schematic diagram of a data processing system, according to certain embodiments, for performing the functions of the exemplary embodiments. The data processing system is an example of a computer in which code or instructions implementing the processes of the illustrative embodiments may be located.

In FIG. 24, data processing system 2400 employs a hub architecture including a north bridge and memory controller hub (NB/MCH) 2425 and a south bridge and input/output (I/O) controller hub (SB/ICH) 2420. The central processing unit (CPU) 2430 is connected to NB/MCH 2425. The NB/MCH 2425 also connects to the memory 2445 via a memory bus, and connects to the graphics processor 2450 via an accelerated graphics port (AGP). The NB/MCH 2425 also connects to the SB/ICH 2420 via an internal bus (e.g., a unified media interface or a direct media interface). The CPU Processing unit 2430 may contain one or more processors and even may be implemented using one or more heterogeneous processor systems.

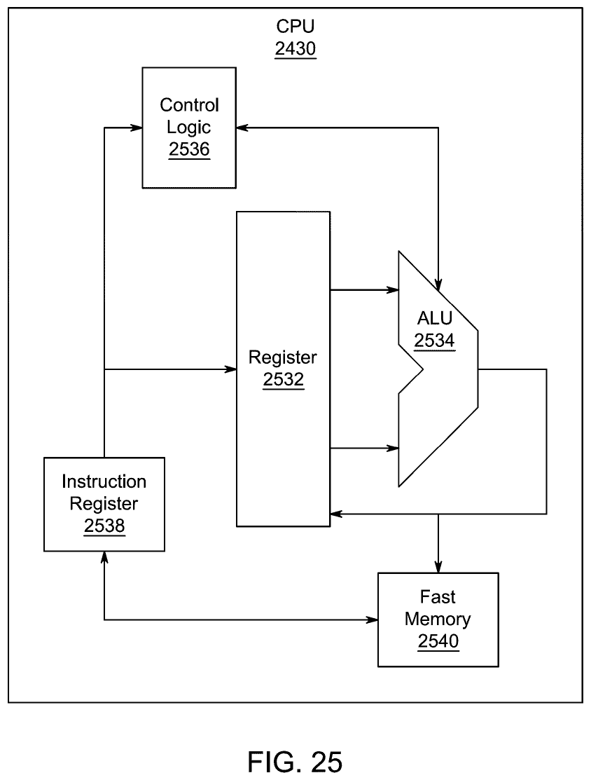

For example, FIG. 25 shows one implementation of CPU 2430. In one implementation, the instruction register 2538 retrieves instructions from the fast memory 2540. At least part of these instructions are fetched from the instruction register 2538 by the control logic 2536 and interpreted according to the instruction set architecture of the CPU 2430. Part of the instructions can also be directed to the register 2532. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 2534 that loads values from the register 2532 and performs logical and mathematical operations on the loaded values according to the instructions. The results from these operations can be feedback into the register and/or stored in the fast memory 2540. According to certain implementations, the instruction set architecture of the CPU 2430 can use a reduced instruction set architecture, a complex instruction set architecture, a vector processor architecture, a very large instruction word architecture. Furthermore, the CPU 2430 can be based on the Von Neuman model or the Harvard model. The CPU 2430 can be a digital signal processor, an FPGA, an ASIC, a PLA, a PLD, or a CPLD. Further, the CPU 2430 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 24, the data processing system 2400 can include that the SB/ICH 2420 is coupled through a system bus to an I/O Bus, a read only memory (ROM) 2456, universal serial bus (USB) port 2464, a flash binary input/output system (BIOS) 2468, and a graphics controller 2458. PCI/PCIe devices can also be coupled to SB/ICH 2488 through a PCI bus 2462.

The PCI devices may include, for example, Ethernet adapters, add-in cards, and PC cards for notebook computers. The Hard disk drive 2460 and CD-ROM 2466 can use, for example, an integrated drive electronics (IDE) or serial advanced technology attachment (SATA) interface. In one implementation the I/O bus can include a super I/O (SIO) device.

Further, the hard disk drive (HDD) 2460 and optical drive 2466 can also be coupled to the SB/ICH 2420 through a system bus. In one implementation, a keyboard 2470, a mouse 2472, a parallel port 2478, and a serial port 2476 can be connected to the system bus through the I/O bus. Other peripherals and devices that can be connected to the SB/ICH 2420 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

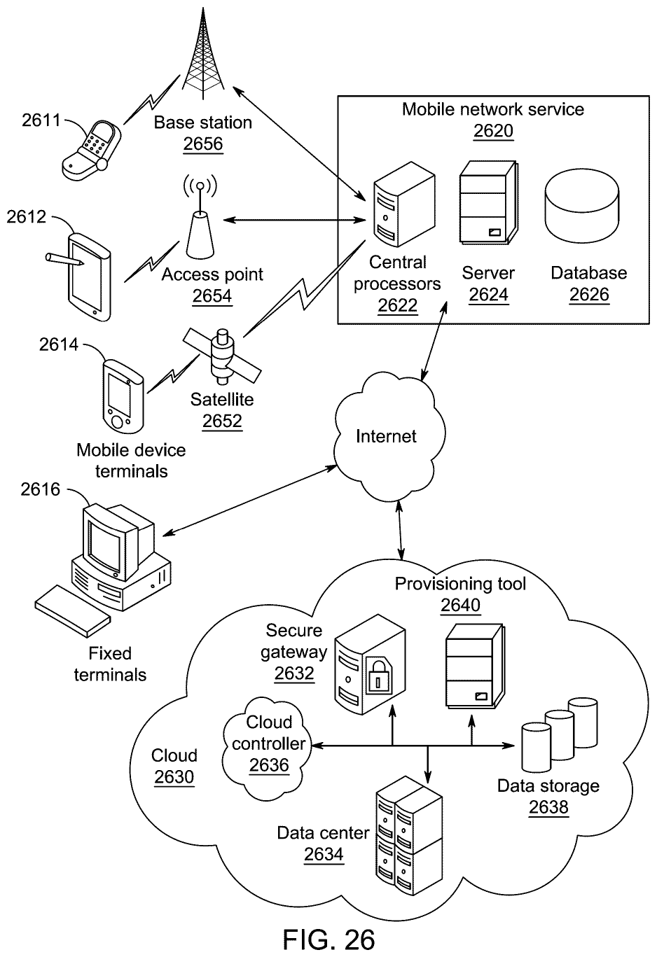

The functions and features described herein may also be executed by various distributed components of a system. For example, one or more processors may execute these system functions, wherein the processors are distributed across multiple components communicating in a network. The distributed components may include one or more client and server machines, such as cloud 2630 including a cloud controller 2636, a secure gateway 2632, a data center 2634, data storage 2638 and a provisioning tool 2640, and mobile network services 2620 including central processors 2622, a server 2624 and a database 2626, which may share processing, as shown by FIG. 26, in addition to various human interface and communication devices (e.g., display monitors 2616, smart phones 2610, tablets 2612, personal digital assistants (PDAs) 2614). The network may be a private network, such as a LAN, satellite 2652 or WAN 2654, or be a public network, may such as the Internet. Input to the system may be received via direct user input and received remotely either in real-time or as a batch process. Additionally, some implementations may be performed on modules or hardware not identical to those described. Accordingly, other implementations are within the scope of the present disclosure.

While specific embodiments of the invention have been described, it should be understood that various modifications and alternatives may be implemented without departing from the spirit and scope of the invention. For example, different cellular automata rules or encryption algorithms could be employed, or alternative feature extraction and face recognition techniques could be integrated into the system.

The above-described hardware description is a non-limiting example of corresponding structure for performing the functionality described herein.

Numerous modifications and variations of the present disclosure are possible in light of the above teachings. It is therefore to be understood that the invention may be practiced otherwise than as specifically described herein.

1. A leak detection system for detecting a plurality of simultaneous leaks within a pipeline system that transports a fluid, comprising:
a valve located at an output port of the pipeline system for perturbing a pressure head in the fluid in response to a valve closure by the valve;
a detachable pressure measurement device for measuring a pressure head at the output port;
a signal acquisition unit for acquiring a transient pressure head signal from the pressure measurement device, wherein the transient pressure head signal includes a random noise;
a neural network model that maps the transient pressure head signal to an output leak function, wherein the output leak function is a probability density function that is proportional to a length of the pipeline system, wherein a dimension of the output leak function is a fixed dimension of an output layer of the neural network model that is independent of a number of leaks; and
a display for displaying the output leak function from the neural network model in conjunction with a drawing of the pipeline system with indications for locations of the plurality of leaks.

2. The leak detection system of claim 1, wherein the display is configured to display the output leak function in which each potential leak point is represented by a density-like lobe, centered at a respective leak location.

3. The leak detection system of claim 2, wherein the display is configured to display the output leak function in which a peak amplitude of the lobe indicates a leak size.

4. The leak detection system of claim 2, wherein the neural network model outputs the output leak function in which a standard deviation of the lobe is proportional to wavelength of the acquired transient pressure head signal.

5. The leak detection system of claim 1, wherein the pipeline system is a tree-type network having three or more connected pipes.

6. The leak detection system of claim 1, wherein the display is configured to display the output leak function as a plot in which a horizontal axis is normalized against pipe length, and a vertical axis is normalized in relation to a cross-sectional area of the pipeline system.

7. The leak detection system of claim 1, wherein the valve is a shut-off valve, and
wherein the neural network model is calibrated to accommodate for variability of closure time of the shut-off value.

8. The leak detection system of claim 1, wherein the valve is a shut-off valve, and
wherein the neural network model is calibrated to accommodate for variations in pre-transient flow rate at the valve location.

9. The leak detection system of claim 1, wherein the valve is a shut-off valve, and
wherein the neural network model is calibrated to accommodate for a combined variability of valve closure time and a pre-transient flowrate.

10. The leak detection system of claim 1, wherein the valve is a shut-off valve, and
wherein the neural network model is calibrated to accommodate for pre-transient pressure head in the pipeline system.

11. The leak detection system of claim 1, wherein the detachable pressure measurement device includes a pressure monitoring device, the system further comprising a connection adapter in which one end is detachably connected to the output port of the pipeline system and another end includes a device port for connecting the pressure monitoring device.

12. The leak detection system of claim 11, wherein the connection adapter is one of a plurality of interchangeable connection adapters of different inner diameters for connection to different types of output ports of various diameters.

13. A method for detecting a plurality of simultaneous leaks within a pipeline system that transports a fluid, comprising:
perturbing a pressure head in the fluid, by a valve located at an output port of the pipeline system, in response to a valve closure by the valve;
measuring, using a detachable pressure measurement device, a pressure head at the output port;
acquiring, by a signal acquisition unit, a transient pressure head signal at the output port, wherein the transient pressure head signal includes a random noise;
generating an output leak function by a neural network model, based on the transient pressure head signal, wherein the output leak function is a probability density function that is proportional to a length of the pipeline system, wherein a dimension of the output leak function is a fixed dimension of an output layer of the neural network model that is independent of a number of leaks; and
displaying, by a display, the output leak function from the neural network model in conjunction with a drawing of the pipeline system with indications for locations of the plurality of leaks.

14. The method of claim 13, wherein the displaying includes displaying the output leak function in which each potential leak point is represented by a density-like lobe, centered at a respective leak location.

15. The method of claim 14, wherein the displaying includes displaying the output leak function in which a peak amplitude of the lobe indicates a leak size.

16. The method of claim 14, wherein the generating, by the neural network model, includes generating the output leak function in which a standard deviation of the lobe is proportional to wavelength of the acquired transient pressure head signal.

17. The method of claim 13, wherein the displaying displays the output leak function as a plot in which a horizontal axis is normalized against pipe length, and a vertical axis is normalized in relation to a cross-sectional area of the pipeline system.

18. The method of claim 13, wherein the output port is configured with a shut-off valve, the method further comprising calibrating the neural network model to accommodate for variability of valve closure time.

19. The method of claim 13, wherein the output port is configured with a shut-off valve, the method further comprising calibrating the neural network model to accommodate for variations in a pre-transient flow rate at the valve location.

20. The method of claim 13, wherein the output port is configured with a shut-off valve, the method further comprising calibrating the neural network model to accommodate for a combined variability of valve closure time and a pre-transient flowrate.
